(19) United States
(12) Patent Application Publication
(10) Pub. No.: US 2026/0219167 A1
(43) Pub. Date: Jul. 30, 2026

(54) MULTIPLE WAVELENGTH ELLIPSOMETER SYSTEM AND METHOD OF USE

(71) Applicant: Film Sense, LLC, Lincoln, NE (US)

(72) Inventors: Blaine D. Johs, Lincoln, NE (US); Bruce A. Hadwiger, Lincoln, NE (US)

(73) Assignee: Film Sense, LLC, Lincoln, NE (US)

(21) Appl. No.: 19/039,741

(22) Filed: Jan. 28, 2025

(51) Int. Cl. G01N 21/21; G01J 4/04

(52) U.S. Cl. CPC G01N 21/211; G01J 4/04

(57) ABSTRACT

The present disclosure relates in general to a multiple wavelength ellipsometer system and method for use in thin film characterization. The multiple wavelength ellipsometer system may include a polarization state generator, a polarization state detector, and combinations thereof. The polarization state generator may have a plurality of solid state light sources, such as but not limited to, sequentially scanned multiple light emitting diodes or laser diodes. In some embodiments, the sequentially scanned multiple light emitting diodes or laser diodes may be mounted in one plane. The polarization state detector may comprise no moving parts. In other embodiments, the polarization state detector may comprise multiple detectors mounted in one plane. In further embodiments, the polarization state detector may utilize economical uncoated glass plates as beam splitters. The system and method of use is designed to compensate for potential measurement errors induced by misalignment of the input beam angle to the polarization state detector via correction factors derived from a Mueller matrix model of the optics. To provide improved accuracy in the analysis of data acquired by the system, methods herein actively compensate for the relatively large bandwidth of the light source.

### TECHNICAL FIELD

The present disclosure relates in general to ellipsometer and polarimeter systems. More specifically, but not exclusively, the present disclosure relates to a multiple wavelength ellipsometer system for characterizing thin film samples. Nonlimiting examples of the present disclosure include implementations of a multiple wavelength polarization state generator and a no moving parts polarimeter.

### BACKGROUND

Ellipsometry is an optical measurement technique that is used for a wide variety of thin film characterization applications. Common uses for the ellipsometry technique are measuring thin film thicknesses and optical constants. Monitoring and controlling thin films is critical for many modern technologies, and ellipsometer systems are routinely used for this purpose, both in Research and Development and for Quality Control.

Ellipsometry is a non-destructive optical technique that measures two quantities at each wavelength. These two quantities characterize the probing beam polarization state change caused by the sample surface reflection. The traditional ellipsometry expression is shown below:

$$Rp / Rs = tan ( ψ ) exp ( i Δ )$$

Rp and Rs are the complex reflectivities for p- and s-polarized light. The complex ratio Rp/Rs is parameterized by the ellipsometric parameters Ψ and Δ: the magnitude of the complex ratio is tan (Ψ), and the phase of the complex ratio is Δ. The ellipsometric Δ parameter provides extreme surface sensitivity, which enables ellipsometers to measure film thickness with sub-nanometer precision. Ellipsometry is not sensitive to the absolute intensity of the measurement beam, as it measures the ratio of p- to s-polarized reflectivity. These are distinct advantages of ellipsometry over the reflectometry technique, which only measures the intensity of the light reflected from the sample. However, ellipsometers are typically complex optical instruments which require expensive polarization optics.

An ellipsometer system often includes a polarization state generator (PSG), a means for supporting the sample being measured, and a polarization state detector (PSD). The PSG includes a source of light, which may be monochromatic, polychromatic, or spectroscopic, and may cover any range of the electromagnetic spectrum. The PSG may also include a means for controlling, setting, and/or modulating the polarization state of the light which is emitted from the PSG. The light emitted from the PSG is reflected from or transmitted through the sample being measured. The interaction of the light from the PSG with the sample alters the polarization state of the beam, which is collected by the PSD. The PSD quantifies the polarization state of the light from the sample. As used herein, the terms Polarization State Detector, PSD, and polarimeter are considered interchangeable. Using the known polarization state set by the PSG, and the polarization state of the beam after interacting with the sample as measured by the PSD, the system can calculate ellipsometric data for the sample. The ellipsometric data for the sample may be further analyzed, using well-known methods to determine sample properties of interest, such as film thicknesses, optical constants, and surface morphology.

Modern ellipsometer configurations differ mainly in the implementations of their PSGs and PSDs. Most modern ellipsometers are photometric instruments which use a modulated signal to improve the speed, precision, and accuracy of the measurement. While many types of modern ellipsometers currently exist in the market, however, these ellipsometers all come with significant deficiencies.

For example, rotating element ellipsometers, which incorporate a mechanically rotating optical element in their PSG and/or PSD, have been extensively reviewed in the literature. See, e.g., R. W. Collins, Automatic Rotating Element Ellipsometers, Calibration, Operation, and Real Time Applications, REVIEW OF SCIENTIFIC INSTRUMENTS, 61, 2029 (1990). Examples of rotating compensator designs are also described in U.S. Pat. No. 5,872,630 to Johs et al. and U.S. Pat. No. 6,320,657B1 to Aspnes et al. Phase modulated systems, which use a piezo-electric transducer to modulate the polarization state of the beam in the PSG and/or PSD, are also described in U.S. Pat. No. 5,757,671 to Drevillon et al. and U.S. Pat. No. 5,956,147 to Jellison, Jr. et al. However, these previously patented designs prove limited in efficiency as they require expensive moving parts that are prone to failure and costly maintenance.

Other ellipsometer configurations are based on the Division Of Amplitudes Polarimeter (DOAP) design. See R. M. A. Azzam, Division-of-amplitude Photopolarimeter (DOAP) for the Simultaneous Measurement of All Four Stokes Parameters of Light, OPTICA ACTA: INTERNATIONAL JOURNAL OF OPTICS, 29(5), 685-689 (1982). Features of the DOAP design include no moving parts and four detectors to enable measurement of all four Stokes parameters which fully characterizes the polarization state of a light beam. No moving parts can potentially result in a lower cost, more robust, and higher speed polarization state detector, which may be highly advantageous for certain applications. Given these important advantages, numerous embodiments of the DOAP approach may be found in the prior art. In a DOAP polarization state detector, the light beam is divided into multiple beams by oblique reflections from beam splitters, detectors, or other optical elements. Since the intensity of the divided beams depends on the angle of the incoming beam, prior art DOAP PSD measurement errors may result if the incoming beam angle is not accurately aligned to the polarimeter.

The “classic” DOAP design uses a coated beam splitter to split the incoming beam into two beams, each of the two beams being further split into two beams by two Wollaston prisms, and the four resulting beam intensities detected by four detectors. A method for designing an optimal coating for the beam splitter has also been disclosed. See R. M. A. Azzam and F. F. Sudradjat, Single-layer-coated beam splitters for the division-of-amplitude photopolarimeter, APPLIED OPTICS, 44, 190-196 (2005). A PSD using this design approach, however, requires two expensive Wollaston prisms and an environmentally degradable custom designed and coated beam splitter. Furthermore, the coated beam splitter may be limited further by operation at a single wavelength. As the optimal beam splitter is sensitive to both the coating properties and the angle of incidence, this design is susceptible to measurement errors induced by misalignment of the incoming beam.

A method for splitting an incoming beam into multiple beams, based on diffraction from a metallic grating, has been disclosed. See R. M. A. Azzam, Division-of-amplitude photopolarimeter based on conical diffraction from a metallic grating, APPLIED OPTICS, 31, 3574-3576 (1992). However, since diffraction from a grating is highly angularly dependent, this DOAP embodiment is also highly susceptible to measurement errors induced by misalignment of the incoming beam.

Another DOAP implementation, using only four photodetectors, is disclosed in U.S. Pat. No. 4,681,450 to Azzam. This design provides a simplistic design with no beam splitters or optical elements required as four photodetectors simultaneously function as polarization dependent beam splitters and detectors. However, optimizing this design requires careful and time consuming orientation of angles and planes of incidences of each detector with respect to the incoming beam, which in turn makes this design highly susceptible to measurement errors induced by misalignment of the incoming beam.

Yet another DOAP implementation, wherein a coated beam splitter is replaced by an uncoated prism, is disclosed in U.S. Pat. No. 6,177,995B1 to Compain et al. The uncoated prism is advantageous in that it may provide optimal polarized separation of the incoming beam in a manner that is relatively independent of both wavelength and beam angle. However, this device may still be relatively expensive to manufacture, as it uses a custom prism cut with specific angles, and two Wollaston prisms. Furthermore, while this design may be optimized to minimize measurement errors due to misalignment of the incoming beam, it suffers from lack of active error compensation.

U.S. Pat. No. 6,836,327B1 to Yao discloses an in-line optical polarimeter. The reference teaches the use of polarization-selective elements arranged in an in-line orientation. Nevertheless, the device of Yao is deficient because the optical detectors are not mounted in a singular plane, making it more expensive to manufacture. Furthermore, Yao's device does not provide active correction for beam misalignment.

U.S. Pat. No. 6,177,706B1 to Shindo et al. discloses a polarimeter design which uses multiple polarization sensitive interfaces to split an incoming beam into multiple beams. The device of Shindo et al., however, suffers from mutual dependent and expensive polarization sensitive interfaces integrally coupled with one or more retardation layers. The device of Shindo et al. further suffers from measurement errors due to beam misalignment.

U.S. Pat. No. 6,043,887 to Allard et al. and U.S. Pat. No. 5,335,066 to Yamada et al. describe additional embodiments of a beam splitting polarimeter designs. These designs require that the incoming beam is split into two sub-beams, and each sub-beam is further split into two sub-beams. These designs also suffer from measurement errors due to beam misalignment, as the detectors are not mounted in a singular plane.

U.S. Pat. No. 5,081,348 to Siddiqui and U.S. Pat. No. 7,038,776B1 to Ansley et al. both describe the utilization of four (4) detector polarimeters wherein the wavefront of the incoming beam is spatially split by optics. This class of polarimeter may be known as a Division of Wavefront Polarimeter (DOWP), and suffer from errors due to changes in the beam uniformity which affect the wavefront split.

U.S. Pat. No. 7,800,755B1 to Poirier et al. discloses a polarimeter having a multi-wavelength source. However, this design requires Newtonian telescope optics, wherein the multi-wavelength source is scanned and operatively connected to a fixed waveplate to convert one polarization state into multiple polarization states.

U.S. Pat. No. 5,548,404 to Kupershmidt et al. describes a multiple wavelength ellipsometer system wherein the multiple wavelength light sources are simultaneously modulated, but at different frequencies. To separate the signals from the different light sources, the system employs an expensive and cumbersome synchronous demodulation scheme.

One light source for efficient ellipsometric data measurements is the known light emitting diode (LED). LEDs have very long operating lifetimes (>50,000 hours), such that no light source replacement would likely be required over the lifetime of the instrument. Solid state laser diodes may also be used in the PSG. The advantages of laser diodes are a much narrower bandwidth and higher intensities. However, compared to LEDs, the operating lifetime of laser diodes can be much lower (<10,000 hours), and the output beam of a laser diode may be more difficult to collect into a uniform collimated beam. Inexpensive LEDs are readily available in a variety of colors in the visible spectral range, and LEDs are also available in the UV and NIR spectral ranges.

One disadvantage to using LED light sources however is the relatively large spectral bandwidth, which may exceed 30 nm Full Width Half Maximum (FWHM) for some colors of LEDs. This large spectral bandwidth can corrupt the data analysis for some samples, especially for thicker films.

U.S. Pat. No. 7,061,612B2 to Johnston emphasizes the advantages of using LEDs as light sources in a polarimeter system. This application however suffers from a single wavelength LED application.

U.S. Pat. No. 7,492,455B1 to Johs et al. discloses a discrete polarization state spectroscopic ellipsometer system. The reference discloses that each light source requires an expensive polarization optic associated with it, such that when the light sources are sequentially scanned, discrete polarization states are emitted from the PSG. A single analyzer element within the PSD is limited to a partial analysis of the Stokes vector of the beam.

U.S. Pat. No. 6,034,777 to Johs et al. discloses a method for characterizing window retardance in ellipsometer and polarimeter systems. However, this reference requires a spectroscopic ellipsometric data set to simultaneously determine window characterizing and sample characterizing parameters. Another method for characterizing window retardance in ellipsometer systems discloses that it is necessary to measure window characterizing properties with the windows removed from the chamber. See G. E. Jellison, Windows in ellipsometry measurements, APPLIED OPTICS, 38, 4784-4789 (1999). However, this approach is inconvenient, and may also be less accurate, because mounting the windows on the chamber may induce changes in the window characterizing properties.

Therefore, a need remains for a system and related method for a multiple wavelength ellipsometer for characterizing thin film samples including efficient implementations of a multiple wavelength PSG and a no moving parts polarimeter.

### SUMMARY

In one aspect of the present disclosure, a multiple wavelength ellipsometer system for use in thin film characterization is provided. A light source for the system may include sequentially scanned multiple light emitting diodes or laser diodes. In some embodiments, the sequentially scanned multiple light emitting diodes or laser diodes are mounted in one plane. The multiple wavelength ellipsometer system may include a polarization state generator, a polarization state detector, and combinations thereof. In particular, the polarization state detector comprises no moving parts. In some embodiments, the polarization state detector may include multiple detectors mounted in one plane. In other embodiments, the polarization state detector may utilize economical uncoated glass plates as beam splitters. The system may compensate for potential measurement errors induced by misalignment of an input beam angle to the polarization state detector via correction factors derived from a Mueller matrix model of the optics. To provide improved accuracy in the analysis of data acquired by the system, methods herein may actively compensate for the relatively large bandwidth of the light source.

According to one or more embodiments of the present disclosure, the multiple wavelength ellipsometer system includes a polarization state generator and a no moving parts polarimeter. The polarization state generator may include a plurality of solid state light sources.

The no moving parts polarimeter may include: a first polarimeter section with an aperture configured to receive an incident beam; a plurality of detectors configured to receive the incident beam and convert the incident beam into one or more detector signals, wherein the plurality of detectors are preferably mounted in one plane; a second polarimeter section including a first partially reflecting optic oriented to partially reflect the incident beam on to a first detector of the plurality of detectors, and to transmit a first remaining incident beam; a third polarimeter section including a second partially reflecting optic oriented to partially reflect the incident beam on to a second detector of the plurality of detectors, and to transmit a second remaining incident beam; a fourth polarimeter section including a third partially reflecting optic oriented to partially reflect the incident beam on to a third detector of the plurality of detectors, and to transmit a third remaining incident beam; a fifth polarimeter section including a fourth partially reflecting optic oriented to partially reflect the incident beam on to a fourth detector of the plurality of detectors, and to transmit a fourth remaining incident beam; a sixth polarimeter section including a reflecting optic oriented to reflect the remaining incident beam on to a fifth detector of the plurality of detectors, wherein the fifth detector is a position sensitive detector; and at least one retarder positioned in between the second polarimeter section and the third polarimeter section, between the third polarimeter section and the fourth polarimeter section, and/or between the fourth polarimeter section and the fifth polarimeter section.

In one or more embodiments of the multiple wavelength ellipsometer system, the plurality of detectors may be mounted onto one circuit board.

In one or more embodiments of the multiple wavelength ellipsometer system, at least one of the detectors may be tilted relative to the plane in which the plurality of detectors are mounted.

In one or more embodiments of the multiple wavelength ellipsometer system, the first polarimeter section may include a focus lens.

In one or more embodiments of the multiple wavelength ellipsometer system, the partially reflecting optics are uncoated transparent glass plates.

In one or more embodiments of the multiple wavelength ellipsometer system, the azimuthal orientation of the planes of incidence of partially reflecting optics are: 0° for the first partially reflecting optic; +45° for the second partially reflecting optic; +45° for the third partially reflecting optic; and 0° for the fourth partially reflecting optic.

In one or more embodiments of the multiple wavelength ellipsometer system, the azimuthal orientation of the retarder element is +45°.

In one or more embodiments of the multiple wavelength ellipsometer system, the plurality of solid state light sources may be mounted in one plane.

In one or more embodiments of the multiple wavelength ellipsometer system, the plurality of solid state light sources may be mounted onto one circuit board.

In one or more embodiments, the multiple wavelength ellipsometer system may further include: a sample housing configured to receive and support a sample; and a common frame configured to support and orient the polarization state generator, the sample housing, and the no moving parts polarimeter.

In one or more embodiments of the multiple wavelength ellipsometer system, the polarization state generator may further include: a first lens configured to collimate the beams from the plurality of solid state light sources; a diffraction grating configured to diffract the output beams from the plurality of solid state light sources into a common beam that is focused by the first lens on to a pinhole; a second lens configured to collimate the common beam which is transmitted through the pinhole; a rotatable polarizer optic azimuthally rotated by a computer controlled motor or a manually rotatable mechanism; and an aperture to define a diameter of the collimated common beam transmitted through the pinhole.

In one or more embodiments of the multiple wavelength ellipsometer system, the common frame may be configured to orient the multiple wavelength ellipsometer system for a plurality of ellipsometer operations, including two or more of: a straight through mode of ellipsometer operation wherein the common beam is directly pointed into the polarimeter; an off sample mode of ellipsometer operation wherein the common beam is directed toward a sample and then reflected from the sample into the polarimeter and/or transmitted through the sample into the polarimeter; and an in situ mode of ellipsometer operation wherein the common frame includes a chamber and the sample is mounted within the chamber, the chamber having a first window for receiving the common beam and transmitting the received common beam to the sample, and a second window for receiving a reflected beam from the sample and transmitting the reflected beam to the no moving parts polarimeter.

In one or more embodiments, the multiple wavelength ellipsometer system may include or is communicatively coupled to at least one processor that is configured to control the plurality of solid state light sources, the control including: sequentially cycling the plurality of solid state lights sources through a series of states, each of the series of states including at least one solid state light source illuminated, or none of the solid state light sources illuminated; and digitizing and storing the detector signals during each of the series of states for further processing.

In one or more embodiments of the multiple wavelength ellipsometer system, the at least one processor may be further configured to perform a calibration to determine a four by four instrument matrix for each wavelength, the calibration comprising steps of: configuring the multiple wavelength ellipsometer system in the straight through mode; inserting a rotatable calibration waveplate into a common beam path between the polarization state generator and the no moving parts polarimeter; rotating the calibration waveplate to one or more azimuthal orientations; rotating the rotatable polarizer optic to at least two azimuthal orientations at each of the one or more azimuthal orientations of the calibration waveplate; storing first output signals from the detectors at each of the one or more azimuthal orientations of the calibration waveplate and at each of the at least two azimuthal orientations of the rotatable polarizer optic; removing the rotatable calibration waveplate from the common beam path; rotating the rotatable polarizer optic in the polarization state generator to at least two azimuthal orientations; storing second output signals from the detectors at each of the at least two azimuthal orientations of the rotatable polarizer optic; and determining, via a non-linear regression analysis and a Mueller matrix model of the device optical components, the four by four instrument matrix for each wavelength based on: the first and second stored output signals from the detectors, the at least two azimuthal orientations of the polarizer optic, the at least one azimuthal orientation of the calibration waveplate, and a retardation of the calibration waveplate at each wavelength.

In one or more embodiments of the multiple wavelength ellipsometer system, the at least one processor may be further configured to perform an acquisition of ellipsometric data, the acquisition of the ellipsometric data comprising steps of: mounting a sample on the common frame; aligning a polarizer optic within the polarization state generator to an operating azimuthal angle; receiving a plurality of detector signals for at least one wavelength from the plurality of solid state light sources; arranging the plurality of detector signals into a four by one signal vector for the at least one wavelength; multiplying the four by one signal vector for the at least one wavelength by an inverse of a four by four instrument matrix to form a four by one product vector, the four by four instrument matrix based on a calibration of the polarization state generator and the no moving parts polarimeter; determining at least one ellipsometric data parameter for the wavelength based on the four by one product vector; storing the determined at least one ellipsometric data parameter for further processing; and displaying the at least one ellipsometric data parameter to a user on a display.

In one or more embodiments of the multiple wavelength ellipsometer system, the at least one processor may be further configured to implement a window calibration of an in situ mode of ellipsometer operation with at least one window in the common beam path, the window calibration comprising steps of: determining an optical model for a reference sample by acquiring ellipsometric data on the reference sample without the at least one window in the common beam path; positioning the reference sample on the common frame and with the at least one window in the common beam path; determining a window calibration data set by acquiring ellipsometric data on the reference sample at multiple orientations of the azimuthally rotatable polarizer optic; determining an ellipsometric N parameter and a window-related Mueller matrix element for at least one wavelength based on the window calibration data set; determining an angle of incidence of the common beam with respect to the reference sample based on the ellipsometric N parameter; determining an ellipsometric C parameter and an ellipsometric S parameter for the reference sample based on the optical model of the reference sample and the angle of incidence of the common beam; determining at least one window characterizing parameter based on the window-related Mueller matrix element, the ellipsometric N parameter, the ellipsometric C parameter, and the ellipsometric S parameter for the reference sample; and storing the at least one window characterizing parameter for use in acquiring ellipsometric data on a subsequent sample to increase the accuracy of the ellipsometric data.

In one or more embodiments of the multiple wavelength ellipsometer system, the at least one processor may be further configured to perform an analysis of the ellipsometric data, the analysis of the ellipsometric data comprising steps of: measuring an intensity versus wavelength for each light source of the plurality of solid state light sources; determining a plurality of lineshape characterizing parameters for each light source of the plurality of solid state light sources by fitting a piece-wise continuous function to the intensity versus wavelength curves for each light source of the plurality of solid state light sources, the piece-wise continuous function have a central Gaussian-like lineshape component and an adjacent exponential-like lineshape component; building an optical model for the sample representative of a nominal structure of the sample, the optical model calculation including a convolution with the fitted piece-wise continuous function with the central Gaussian-like lineshape component and the adjacent exponential-like lineshape component; analyzing the ellipsometric data via a non-linear regression analysis from the optical model for the sample to determine at least one sample characterizing parameter; storing the determined at least one sample characterizing parameter for further processing; and displaying the at least one sample characterizing parameter to a user on a display.

In one or more embodiments of the multiple wavelength ellipsometer system, the at least one processor may be further configured to improve the accuracy of the ellipsometric data when the common incident beam is misaligned to the no moving parts polarimeter by performing steps of: using the detector signals from the position sensitive detector to calculate the misalignment angles of the common beam to the no moving parts polarimeter; using the misalignment angles of the common beam, and a Mueller matrix model of the device optical components determined during the instrument calibration, to calculate a misalignment correction matrix for the four by four instrument matrix at each wavelength; and using the four by four instrument matrix plus the misalignment correction matrix to calculate ellipsometric data with improved accuracy.

In one or more embodiments of the multiple wavelength ellipsometer system, beams reflected from surfaces of the plurality of detectors may be absorbed by blackened regions or holes on a frame of the no moving parts polarimeter.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The Detailed Description is provided with reference to the accompanying Drawings.

The use of the same reference numbers in different instances in the Detailed Description and the Drawings may indicate similar or identical items. The Drawings are not necessarily to scale, and any disclosed processes may be performed in an arbitrary order, unless a certain order of steps/operations is inherent or specified in the Detailed Description or in the Claims. In the Drawings:

FIG. 1 is a diagram of an ellipsometer system configured in a straight through mode, in accordance with an embodiment of this disclosure;

FIG. 2 is a diagram of an ellipsometer system configured in an off sample mode, in accordance with an embodiment of this disclosure;

FIG. 3 is a diagram of an ellipsometer system configured in an in situ mode, in accordance with an embodiment of this disclosure;

FIG. 4 is a schematic diagram showing a front view of a polarization state generator using a diffraction grating to combine light from multiple sources into a common beam geometry, in accordance with an embodiment of this disclosure;

FIG. 4A is a schematic diagram showing a top view of the polarization state generator of FIG. 4, the bottom view being a mirror image thereof;

FIG. 4B is a schematic diagram showing a right side view of the polarization state generator of FIG. 4, the left side view being a mirror image thereof;

FIG. 5 is a schematic diagram of a polarization state detector employing a plurality of beam splitters and detectors, in accordance with an embodiment of this disclosure;

FIG. 6 is an isometric view of a coordinate system for a beam splitter which may be utilized, in accordance with an embodiment of this disclosure;

FIG. 6A is an incidence plane view of the coordinate system for a beam splitter of FIG. 6;

FIG. 6B is an incident beam view of the coordinate system for a beam splitter of FIG. 6;

FIG. 7 is an isometric view showing how the optical components are mounted for the polarization state detector, in accordance with an embodiment of this disclosure;

FIG. 8 is a diagram showing how detectors may be tilted from the common circuit board, in accordance with an embodiment of this disclosure;

FIG. 9 is a graph of polarized reflection and transmission curves for an uncoated fused silica glass plate vs. angle of incidence, in accordance with an embodiment of this disclosure;

FIG. 10 is a diagram showing the reflection and transmission of aligned and misaligned beams from a beam splitter, in accordance with an embodiment of this disclosure;

FIG. 11 is a graph of Spectral intensity profiles for the LED light sources, with lineshape fit curves, in accordance with an embodiment of this disclosure;

FIG. 12 is a graph of the piece-wise continuous Gaussian+Exponential lineshape fitting function, in accordance with an embodiment of this disclosure;

FIG. 13 is a table of lineshape characterizing parameters for the LED spectral intensity profiles, in accordance with an embodiment of this disclosure;

FIG. 14 is a plot of the degree of polarization P vs. film thickness, using different convolution lineshapes, in accordance with an embodiment of this disclosure; and

FIG. 15 is a graph of the ellipsometric Fit Diff vs. film thickness, using different convolution lineshapes, in accordance with an embodiment of this disclosure.

### DETAILED DESCRIPTION

While certain embodiments of the present disclosure are shown and described herein, it is understood that such aspects are merely exemplary. The present disclosure is not intended to be limited to these specific aspects and may encompass other aspects or embodiments. Therefore, specific system and method details disclosed herein are not to be interpreted or inferred as limiting, but merely as a basis for the claims and as a representative basis for teaching one skilled in the art how to make and use the disclosed subject matter.

It must be noted that the singular terms “a,” “an,” and “the” as used herein may include plural referents unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means.

All words of approximation as used in the present disclosure and claims should be construed to mean “approximate,” rather than “perfect” or “exact,” and may be used as a modifier to any other word, number, quantity, quality, value, or specified parameter. Words of approximation, include, but are not limited to terms such as “about,” “approximately,” “around,” “almost,” “generally,” “largely,” “essentially,” “substantially,” etc.

Furthermore the transitional phrase “comprising” that is synonymous with “including,” “containing,” and “characterized by” as used herein is inclusive or open-ended and does not exclude additional, unrecited elements, steps or ingredients. Alternatively the transitional phrase “consisting of” as used herein is closed and excludes any element, step or ingredient not specified. The transitional phrase “consisting essentially of” limits the scope of a claim to the specified materials or steps and those that do not materially affect the basic and novel characteristics of the claims.

A goal of the present disclosure is to provide a robust, low cost, easily manufactured multiple wavelength ellipsometer system for use in thin film characterization. This goal is met by a novel multiple wavelength polarization state generator, which uses sequentially scanned solid state light sources that are preferably mounted in one plane, combined with a no moving parts polarization state detector. The presently disclosed polarization state detector may utilize uncoated glass plate beam splitters, and a plurality of detectors to detect the full polarization state of the beam. In some embodiments, the plurality of detectors may be mounted in one plane. To compensate for potential measurement errors that may be induced by misalignment of the incoming beam, correction factors are derived from a Mueller Matrix model of the polarization state detector optics.

The present disclosure improves upon the inventors' previous work as described in U.S. Pat. No. 9,354,118 to Johs et al. (hereinafter, “the '118 patent”), which discloses a multiple wavelength ellipsometer system, and is incorporated herein by reference. Some key differences between the '118 patent and the present disclosure include, but are not limited to, the following: 1) unlike the '118 patent, the present disclosure teaches that the solid state light source elements in the PSG may be mounted in one plane, and the detector elements in the PSD may also be mounted in one plane, both of which can significantly improve the manufacturability of the system; 2) while the '118 patent discloses the use of a diffraction grating in the PSG, the present disclosure may utilize one lens to collimate the light emitted from the sources before it reaches the diffraction grating, and the same lens to focus the light reflected from the diffraction grating, which improves the collection efficiency and spectral uniformity in the combined common beam; and 3) the '118 patent uses a paired arrangement of beam splitters and detectors to compensate for measurement errors induced by misalignment of the input beam, while the present disclosure does not require the paired arrangement of beam splitters and detectors, thereby reducing the number of beam splitters and detectors required in the system, and instead uses correction factors derived from a Mueller Matrix model of the optics to correct for measurement errors induced by misalignment of the input beam.

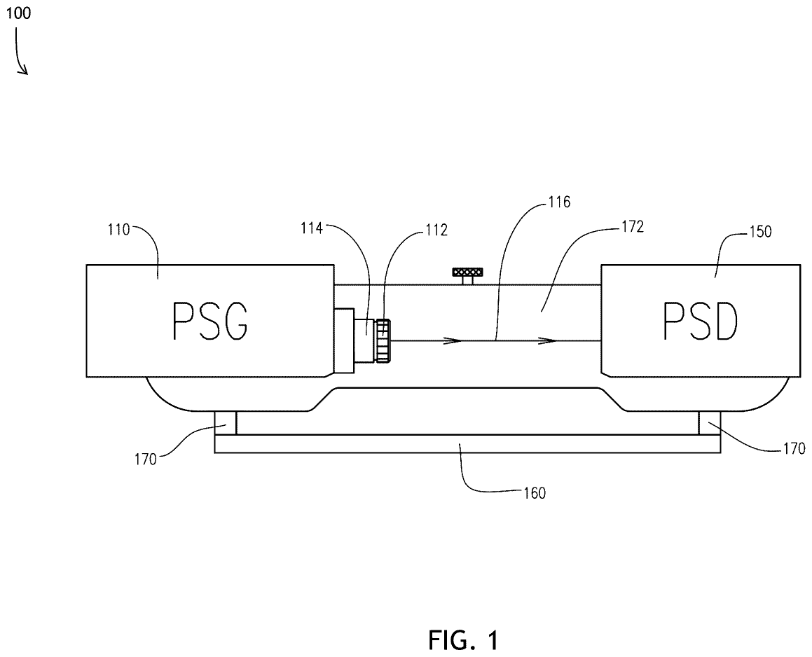

As shown in FIGS. 1 through 3, the presently disclosed multiple wavelength ellipsometer system 100 comprises two main components: a polarization state generator (PSG) 110; and a polarization state detector (PSD) 150.

FIG. 1 shows the PSG 110 and PSD 150 mounted to a common frame, configured in the straight through mode of operation. In this mode, the light beam 116 emitted from the PSG 110 is pointed directly into the PSD 150. The embodiment in FIG. 1 shows the PSG 110 and PSD 150 fixed to a common back plate 172. PSG 110 may provide a common beam 116 for ellipsometric analysis as discussed below. The common frame may include a back plate 172 connected to a base 160 by vertical supports 170. Also shown in FIG. 1 is a Wave Plate (WP) 114 and WP Rotator 112; these elements are added to the beam path when performing calibration in the straight through mode, as discussed below.

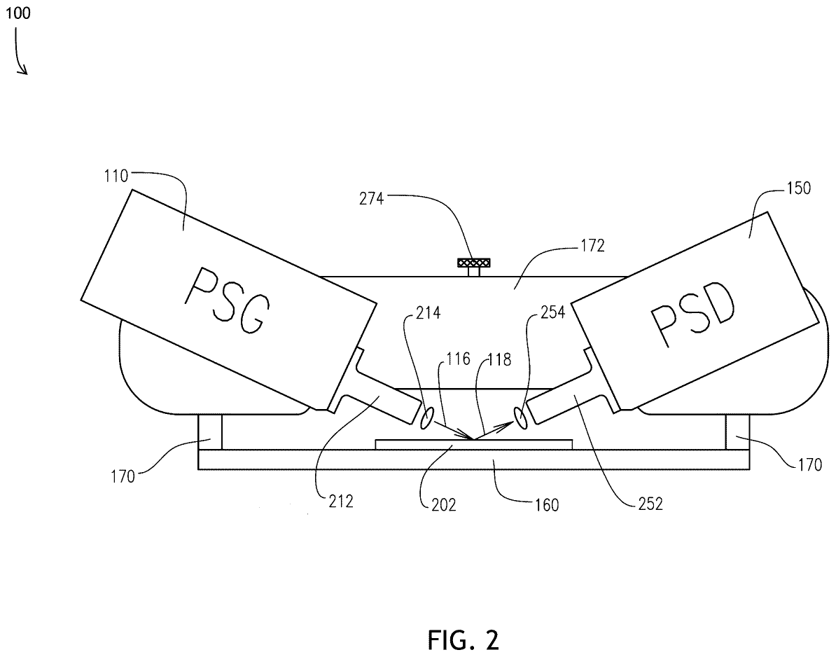

FIG. 2 shows system 100 configured in the off sample mode of operation. As in the straight through mode of operation, the PSG 110 and PSD 150 are fixed to a common back plate 172. However, in this mode of operation, PSG 110 and PSD 150 are mounted at angles such that the light beam emitted from the PSG 110 is pointed onto a sample, reflected from the sample 202, and enters the PSD 150. The sample 202 rests on a Base plate, the Base may be connected to Vertical Supports, and the Vertical Supports are connected to the back plate 172. If a sliding mechanism is introduced in between the Vertical Supports and the back plate 172, then the height adjustment knob 274 may be used to adjust the height of the PSG 110 and PSD 150 units relative to the sample 202 surface. The procedure of adjusting the height to center the beam reflected from the sample 202 onto the PSD 150 aperture may be known as “aligning the sample” or “sample alignment”. The sample 202 alignment procedure may also optionally involve tilting the sample 202 to adjust the angle of the incoming beam to the PSD 150. Also shown in FIG. 2 are lens mounts 212 and 252, focusing lens 214 to focus the common beam 116, and collection lens 254 to collimate reflected beam 118. These optional elements may be used to reduce the size of the probing light beam on the sample 202 surface.

When system 100 is operated in the off sample mode, another type of calibration is required. In the off sample calibration procedure, the azimuthal rotation angles of the PSG 110 and PSD 150 with respect to the sample 202 plane of incidence are determined. The steps for the off sample calibration procedure are: mount and align a sample, rotate the polarizer optic in the PSG 110 to multiple azimuthal orientations, acquire and store raw data at each azimuthal orientation of the polarizer optic, and then analyze the stored raw data, using non-linear regression analysis with the previously determined 4×4 instrument matrix for the Polarization State Detector and a Mueller Matrix model for the PSG and sample to simultaneously determine the azimuthal rotation angles of the PSG 110 and Polarization State Detector, and the ellipsometric parameters of the sample 202 at each wavelength. In one embodiment, 8 azimuthal angles are used for the polarizer optic (−90°, −67.5°, −45°, −22.5°, 0°, +22.5°, and +45°).

After system 100 has been calibrated in the straight through and off sample modes, system 100 may acquire accurate ellipsometric data. The steps for acquiring ellipsometric data are: mount and optionally align a sample, set the azimuthal orientation of the polarizer optic in the PSG 110 to the designated orientation for data acquisition, acquire and store raw data at each wavelength, pack the raw data into 4×1 signal vectors at each wavelength, multiply the 4×1 signal vectors at each wavelength times the inverse of the 4×4 instrument matrices at each wavelength to form 4×1 product vectors at each wavelength, calculate the effective ellipsometric data parameters at each wavelength from the 4×1 product vectors at each wavelength, and store the effective ellipsometric data parameters at each wavelength for further processing and display. Note that the calculation of ellipsometric data parameters from the 4×1 product vectors at each wavelength may include other calibration factors, such as the azimuthal rotation angles for the PSG 110 and Polarization State Detector, which were determined in the off sample calibration procedure. In one embodiment, the designated azimuthal orientation of the polarizer optic for data acquisition may be +45° or −45°. Zone-averaged measurements may also be performed to improve the accuracy of the ellipsometric measurements, that is, one data set is acquired with the polarizer optic at +45°, then a second data is acquired with the polarizer optic at −45°, and then the first and second data sets are averaged.

Stress-induced birefringence in windows and lenses which are in the beam path of the ellipsometer system may cause inaccuracies in the measured ellipsometric data. The present disclosure provides a method for accurately characterizing and correcting for the effects of windows and lenses in the beam path of the presently disclosed ellipsometer system 100.

When practicing this method, a reference sample may be separately measured without a window in the beam path to determine the optical model for the reference sample. If it is not possible to measure the reference sample without a window in the beam path, a nominal model may be assumed for the reference sample. Then the reference sample is mounted, a windows correction procedure performed, using the previously determined or assumed optical model for the reference sample, to determine the angle of incidence of the beam with respect to the sample 202 inside the change and the three window calibration parameters (at each wavelength in the ellipsometer system), and then, system 100 may acquire accurate ellipsometric data using the three window calibration parameters to correct for the polarization effects of the windows present in the ellipsometer beam path.

After acquiring an ellipsometric Data Set on a sample (the Data Set comprising experimentally measured ellipsometric parameters at multiple wavelengths), system 100 may determine sample parameters of interest, such as film thickness, optical constants, surface morphology, etc., through analysis of the ellipsometric Data Set. One common method of analyzing ellipsometric Data Sets may be to perform a well-known model-based, least squares, non-linear regression analysis of the data set. The present disclosure overcomes traditional obstacles in the model calculation of analysis to accurately accommodate for the large spectral bandwidth of the LED light sources. This procedure includes the steps of: measuring the intensity spectra of each LED (using an external spectrometer system that is not part of system 100); parameterizing the intensity spectra by a piece-wise continuous functions of Gaussian+Exponential lineshapes; and evaluating the spectral bandwidth convolution integral with the LED lineshape and the incoherent intensity parameters calculated from the optical model.

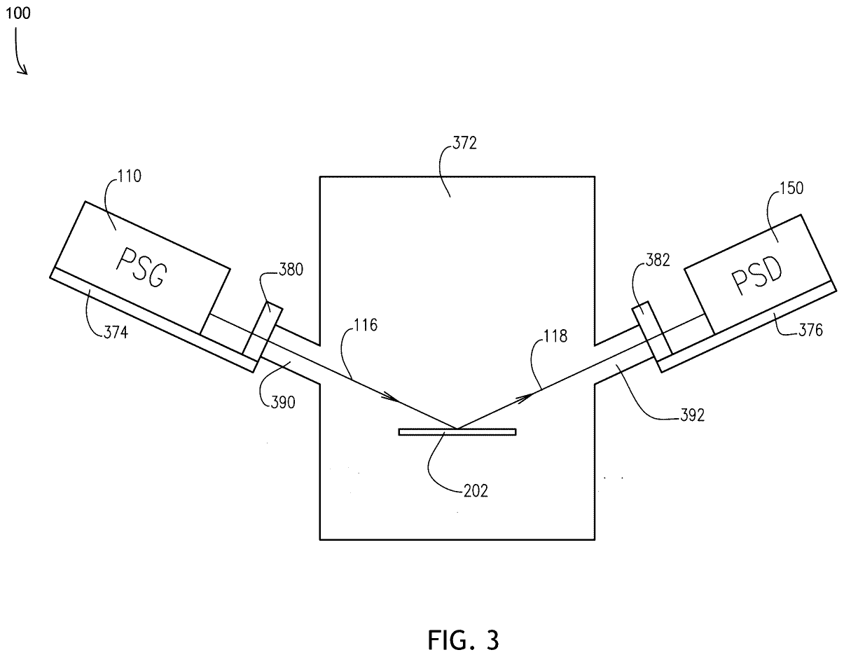

FIG. 3 shows an embodiment of system 100 configured for the in situ mode of operation. Chamber 372 may be a vacuum chamber, a liquid cell, and/or other type of processing chamber. Ports 390, 392 allow optical access to a sample located inside the chamber 372. The ellipsometer beam exits the PSG 110, passes through a first window 380, passes through a first port 390, reflects off the sample 202, passes through a second port 392, passes through a second window 382, and enters the PSD 150. Mounts 374 and 376 may be used to attach the PSG 110 and PSD 150 to the chamber 372. In one embodiment, mounts 374 and 376 provide tilt adjustments such the beam from the PSG 110 may be pointed onto the sample 202 by adjusting the tilt on 374, and the tilt on 376 may be adjusted to align the PSD 150 with the angle of the incoming beam.

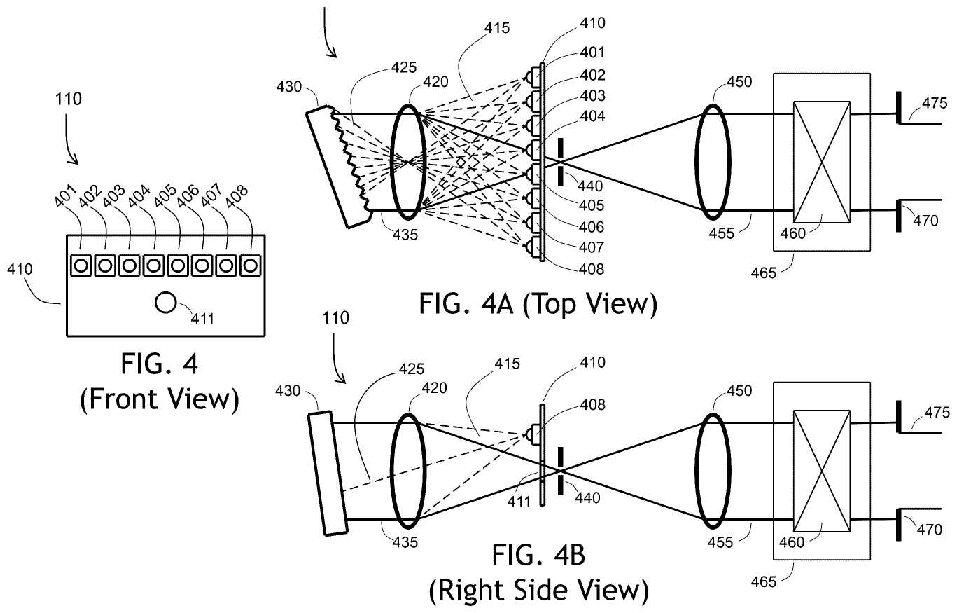

FIGS. 4 through 4B shows one embodiment of multiple wavelength PSG 110. In this embodiment, a plurality of solid state light sources are mounted on a common circuit board, and a lens and diffraction grating are used to combine the individual beams from the light sources into a common beam. As an example, FIG. 4 shows a Front View of 8 solid state light sources (401-408) mounted on a common circuit board 410. Preferably, the solid state light sources are Light Emitting Diodes (LEDs), each of which emit different colors of light, and they are surface mount devices that can be accurately placed on the circuit board. The circuit board 410 also has a hole 411, which allows the common beam reflected from the grating to pass through the board. FIG. 4A and FIG. 4B show Top and Side Views of the PSG light source board 410 and the PSG optics. These figures provide a schematic representation of the PSG light source; for clarity, the component locations and sizes are not drawn to scale, and only primary light rays are shown. Light is emitted from LEDs 401-408 over a wide angular range (typically >) 90°, which is shown by the dashed lines 415. Lens 420 collimates the wide angular range light from the LEDs into collimated beams 425 (only the “center rays” are shown). The collimated beams 425 have different angles of propagation, due to the different positions of the light sources. The beams 425 then reflect and diffract from the diffraction grating 430. The LEDs 401-408 are positioned (as shown horizontally in the Front View FIG. 4, and vertically in the Top View FIG. 4A) on the circuit board 410 such that diffraction grating combines the different colors of light emitted from the different LEDs into a common collimated beam 435.

The LED positions can be calculated using the grating equation below, where d is the grating constant of the grating, m is the order of the diffracted light, λ is the wavelength of the light, θᵢ is the angle of the incident light on the grating, and θₘ is the angle of the diffracted light from the grating 430.

d(sin θᵢ+sin θₘ)=mλ

In the present disclosure, the diffraction grating 430 is tilted (as shown in the FIG. 4A Top View) and the LEDs 401-408 are positioned such that the grating equation is satisfied at each wavelength of each LED. For example, one embodiment is to set θₘ=24°, m=1, and d=833 (which corresponds to a 1200 groove/mm grating). For a 22 mm distance between the common circuit board 410 and the collimating lens 420, and nominal LED wavelengths of 365, 455, 525, 595, 660, 735, 860, and 950 nm, the horizontal positions of each LED (in the Front View FIG. 4, measured from the center of hole 411) are: −8.98, −6.31, −4.32, −2.35, −0.51, +1.68, +5.77, and +9.41 mm. These positions provide adequate separation for commercially available surface mount LEDs, which have typical sizes of ≈1.3×1.7 mm (for example, the LUXEON Z Color Line of LEDs from LUMILEDS).

Continuing on, the common collimated beam 435 passes through lens 420, which focuses the beam through the hole 411, and on to a pinhole 440. To achieve this, the grating 430 is slightly tilted, as the LEDs 401-408 and the hole 411 are vertically separated (as shown in FIG. 4 Front View and FIG. 4B Side View). This means that the grating is tilted in 2 planes, therefore operates in a “conical diffraction” mode. However, if the vertical separation between the LEDs and hole 411 is small (for example, <3 mm) compared to the focal length of the lens 420 (for example, 25 mm), the required grating tilt angle (shown in the FIG. 4C Side View) is also small. Therefore, the aberrations introduced by conical diffraction are minimal, and the ideal grating equation above can still be used with acceptable performance.

Light which transmits through the pinhole 440 is collimated by lens 450. The polarization state of the collimated beam 455 is set by the polarizer optic polarizer optic 460, which may be mounted in a manual or motorized rotation mechanism 465. The polarized and collimated beam 475 then exits the PSG 110 through an aperture 470. The polarizer optic 460 may use a high quality, but more expensive, crystal polarizer. Sheet polarizers provide more compact and low cost options for the polarizer element. However, if sheet polarizers are used, their non-ideal polarizing properties may have to be accounted for in the instrument calibration procedure.

The rotatable polarizer 460 in the PSG 110 may be fixed during normal operation of the instrument, but it may also be rotated to discrete azimuthal orientations during the instrument calibration procedure or to implement Zone Averaged measurements. The rotation mechanism 465 for the polarizer element 460, may be implemented by a motorized mount and controlled by a processor.

Embodiments of the present disclosure account for the spectral bandwidth of the LED sources in the data analysis procedure by incorporating the effects the LED bandwidth in the data analysis. This procedure may include the steps of measuring the intensity spectra of each LED (using an external spectrometer system which is not part of system 100), parameterizing the intensity spectra by a piece-wise continuous function of Gaussian+Exponential lineshapes, and evaluating the spectral bandwidth convolution integral with the LED lineshape and the incoherent intensity parameters calculated from the optical model.

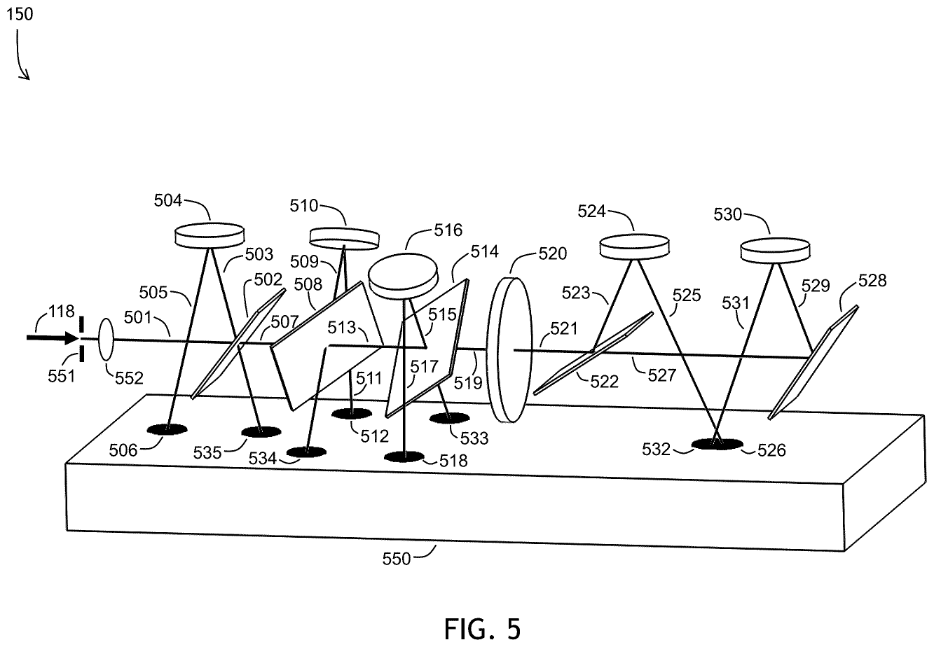

FIG. 5 shows a schematic representation of one embodiment of the internal components of no moving parts detector PSD 150. The internal components may be mounted to a common frame 550 (for clarity, the mounting components are not shown in the schematic FIG. 5). The incident beam 118 enters the PSD 150 through an aperture 551, and may pass through optional lens 552. Input beam 501 is incident on first beam splitter 502, which partially reflects beam 503 into first detector 504. Beam 505 is partially reflected from the surface of first detector 504 and is then absorbed by the blackened region 506. Beam 507 is transmitted through first beam splitter 502 and is incident on second beam splitter 508, which partially reflects beam 509 into second detector 510. Beam 511 is partially reflected from the surface of second detector 510 and is then absorbed by the blackened region 512. Beam 513 is transmitted through second beam splitter 508 and is incident on third beam splitter 514, which partially reflects beam 515 into third detector 516. Beam 517 is partially reflected from the surface of third detector 516 and is then absorbed by the blackened region 518. Beam 519 is transmitted through third beam splitter 514 and is normally incident on retarder element 520. Beam 521 is transmitted through retarder element 520 and is incident on fourth beam splitter 522, which partially reflects beam 523 into fourth detector 524. Beam 525 is partially reflected from the surface of fourth detector 524 and is then absorbed by the blackened region 526. Beam 527 is transmitted through fourth beam splitter 522 and is incident on mirror 528, which reflects beam 529 into position sensitive detector 530. Beam 531 is partially reflected from the surface of position sensitive detector 530 and is then absorbed by the blackened region 532.

Note that beam 519 which is normally incident on retarder element 520 may be partially reflected back towards the aperture 551. This back reflected beam will be partially reflected by third beam splitter 514 and then absorbed by the blackened region 533, partially reflected by the second beam splitter 508 and then absorbed by the blackened region 534, and partially reflected by the first beam splitter 502 and then absorbed by the blackened region 535.

The blackened regions 506, 512, 518, 526, 532, 533, 534, and 535 absorb the light beams that are partially reflected from the detector and retarder element surfaces, thereby preventing non-ideal spurious reflections from internal surfaces inside the PSD 150. Non-ideal spurious reflections could scatter into other detectors, which could corrupt the accuracy of the data acquired by the PSD 150. The blackened light absorbing regions could be implemented by painting the surface of common frame 550 with matte black paint, or by holes drilled in common frame 550 (which may also be painted with matte black paint), or by any other surface treatment or film (such as black flocking paper) which would effectively absorb the light beams. The blackened regions may also overlap or partially overlap, for example, 526 and 532.

In one embodiment, detector 530 may be a 2-dimensional Position Sensitive Detector. Well-known 2-dimensional Position Sensitive Detectors have four output signals (X1, Y1, X2, Y2) which may be processed into the x,y location where the beam hits the Position Sensitive Detector. Using the distance between the aperture 551 and position sensitive detector 530, the x,y location from the Position Sensitive Detector may be converted into an angular measure of the incident beam 501 with respect to the Polarization State Detector by using simple trigonometry. A lens 552 may optionally be placed in the beam path after the aperture to focus the beam on the Position Sensitive Detector, which may improve the accuracy of the angular measurement of the incoming beam.

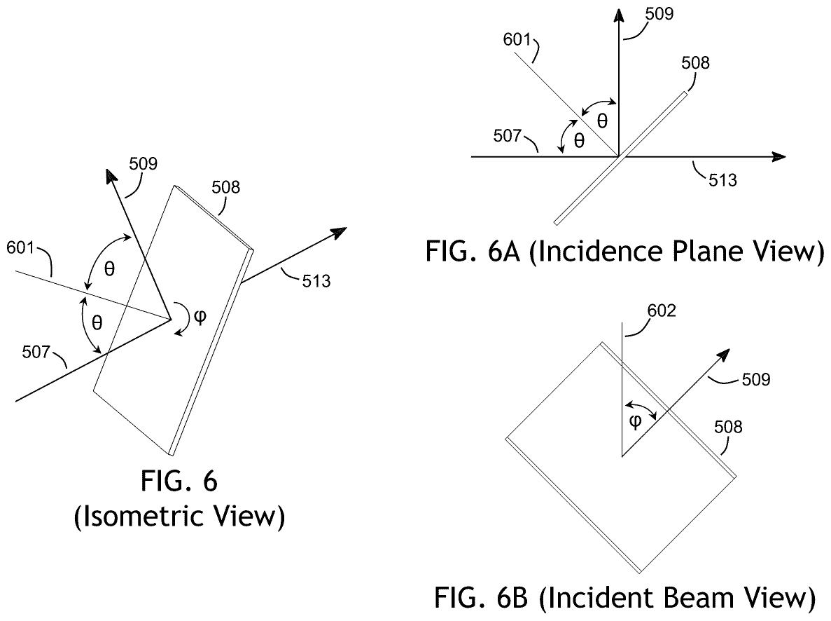

To provide sensitivity to different polarization components of the incoming beam, the beam splitters 502, 508, 514, and 522 may be tilted with respect to the incident beam, and their plane of incidence may also be azimuthally rotated about the beam axis. The coordinate system for a beam splitter relative to the incident beam is defined in FIGS. 6 through 6B. An isometric view is presented in FIG. 6, in which a beam 507 is incident on beam splitter 508, which partially reflects beam 509 (and the remaining beam 513 is transmitted through 508). The surface normal 601 to beam splitter 508 is also shown in FIG. 6. The angle of incidence θ between the incident beam 507 and the surface normal 601 is equal to the angle of reflection θ between the reflected beam 509 and the surface normal 601, due to the physics of how light reflects from surfaces. The incident beam 507, the surface normal 601, and the reflected beam 509 are all in the same plane, which is denoted the “plane of incidence”. The beam splitter 508 can also be azimuthally rotated around the beam 507 axis, and this rotation angle is denoted φ. FIG. 6A shows the beam splitter coordinate system when viewed in the plane of incidence, which clearly shows the angle of incidence θ. FIG. 6B shows the beam splitter coordinate system when viewed in the direction of the incident beam, which clearly shows the azimuthal rotation angle φ. φ is defined relative to a reference plane 602, that typically coincides with the plane of incidence of the beam reflected from the sample 202.

The angle of incidence θ and azimuthal rotation angle φ can be used to specify a Mueller Matrix for a beam splitter, and the Mueller Matrices of all the optics in system 100 can be combined to calculate the Instrument Matrix for the PSD 150. To design an optimal PSD 150 system, the θ and φ angles of all the beam splitters in system 100 should be chosen such that each beam splitter and detector pair is sensitive to linearly independent components of the polarization state of the input beam, which in turn results in a 4×4 Instrument Matrix that is invertible. Furthermore, it is preferable that all the detectors are mounted in one plane, and the partially reflected beams from the detector surfaces do not impinge on other optics in system 100 but are instead absorbed by blackened regions. For example, one embodiment of the present invention specifies θ=38° and φ=0° for the first beam splitter 502, θ=45° and φ=−45° for the second beam splitter 508, θ=45° and φ=+45° for the third beam splitter 514, and θ=57° and φ=0° for the fourth beam splitter 522. Inserting one or more retardation elements in between the beam splitters may be another way to produce sensitivity to different polarization components. In one embodiment of the present disclosure, a waveplate 520 may be inserted in the beam path before the fourth beam splitter 522. The retardance of waveplate 520 may be 90° at 532 nm, and the azimuthal orientation may be +45° or −45°.

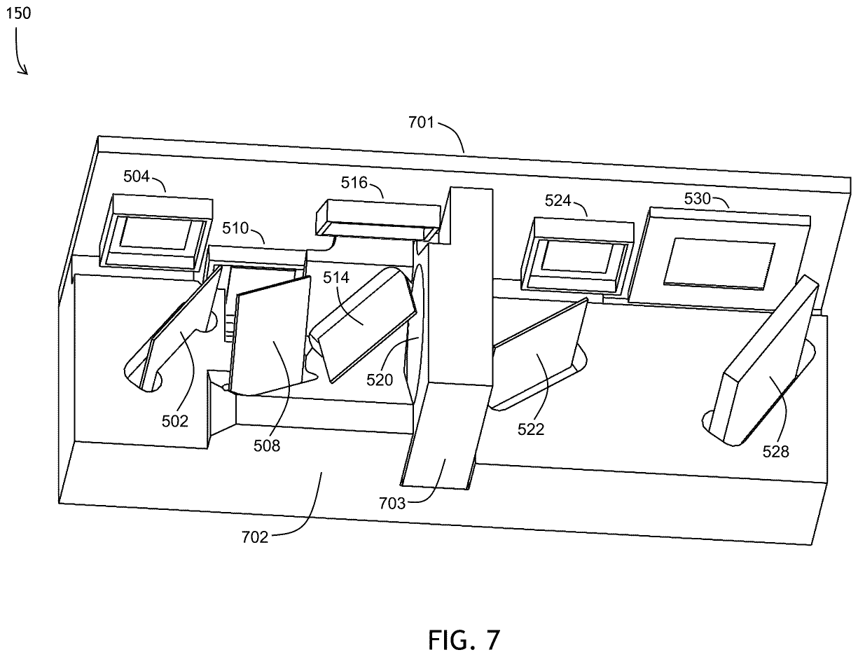

FIG. 7 is an isometric view of PSG 150 (from the bottom side, looking through common frame 550), showing how the optical components could be mounted for the preceding embodiment of system 100 (for clarity, the beams are not shown). The detectors 504, 510, 516, 524, and 530 are mounted on a common circuit board 701. The beam splitters 502, 508, 514, and 522, and mirror 528 are mounted on block 702. The retarder element 520 is mounted in block 703. Blocks 702 and 703 may be mounted on a common frame 550 (which is hidden in the figure). To minimize stress, the optics may be mounted on blocks 702 and 703 using a flexible adhesive, such as RTV silicone. Fabricating the slots in block 702 for the beam splitters at the various angles in three dimensions can be challenging, but block 702 can be readily manufactured by a multi-axis CNC machine, or by 3D printing.

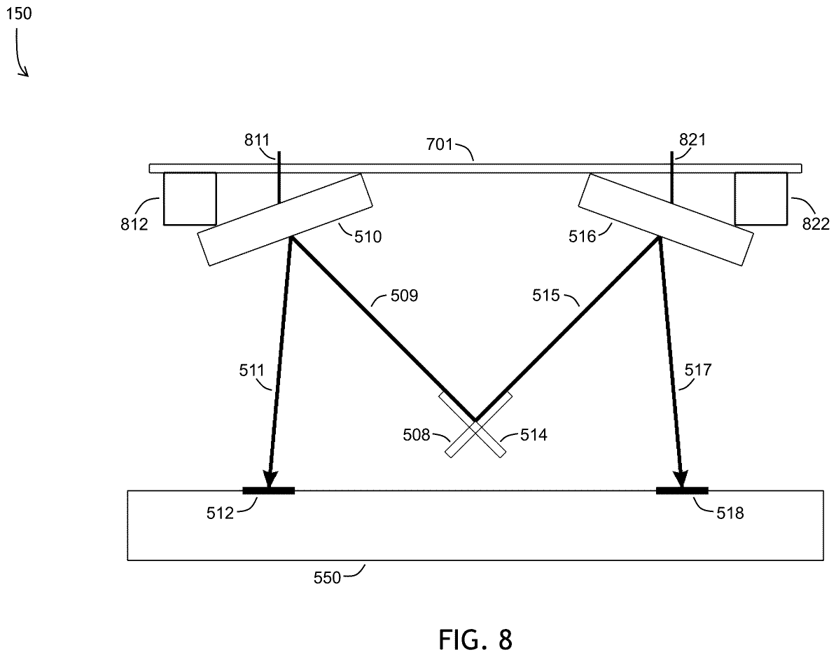

In the preceding embodiment, the φ=±45° values for the second and third beam splitters (508 and 514) may cause the reflected beams (509 and 515) to impinge on the second and third detectors (510 and 516) at a relatively oblique angle. The oblique incidence angle increases the polarization effects of the detector, and the partially reflected beams from the detector surfaces (511 and 517) may impinge on other internal surfaces of the PSG 150, resulting in non-ideal spurious reflections. To mitigate these effects, the detectors 510 and 516 may be tilted from the surface of a common circuit board 701 in which the plurality of detectors are mounted. This is demonstrated in FIG. 8, which shows a schematic view of the tilted detectors, looking in the direction of beam 501 which enters PSD 150. Beam 501 is partially reflected by beam splitters 508 and 514 into beams 509 and 515. Detectors 510 and 516 are mounted on a common circuit board 701, by electrical leads 811 and 821. Optional spacer blocks 812 and 822 are located under an edge of detectors 510 and 516 to effect a tilt, which directs the partially reflected beams 511 and 517 into the blackened regions 512 and 518.

In an example embodiment, PSD 150 may use four beam splitters and detectors. The beam splitters may utilize any type of partially reflecting, partially transmitting device, including cube beam splitters and plate beam splitters with custom coatings. Beam splitters in system 100 may preferably include uncoated glass plates, which may be fabricated using common optical materials such as BK7 glass and fused silica. Uncoated glass plates are inexpensive, more likely to be environmentally stable, and also provide relatively achromat reflection and transmission characteristics.

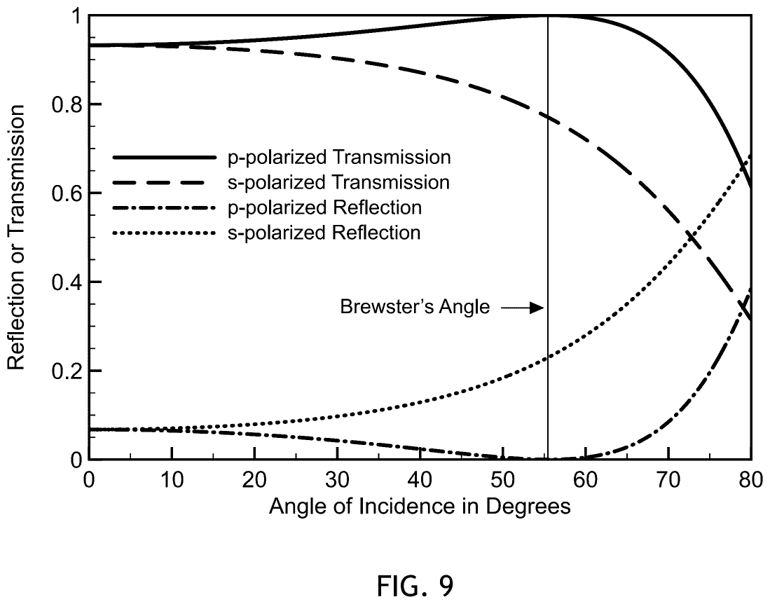

FIG. 9 shows the reflected and transmitted light from a fused silica glass plate vs. Angle of Incidence (AOI), calculated using the well-known Fresnel equations. The wavelength used for the calculation was 546 nm; for fused silica, the corresponding index of refraction is 1.46. One noteworthy feature on the graph in FIG. 9 is that the p-polarized reflection curve goes to zero near 55 degrees Angle of Incidence. This angle of minimum reflectivity is known as “Brewster's Angle” (s-polarized light does not exhibit this effect). An uncoated glass plate beam splitter may act as an ideal polarizer at Brewster's Angle, as the reflected p-polarized light is completely extinguished. However, for any incidence angle greater than approximately 30°, the beam splitter can still act as a partial polarizer, and the ratio between s- and p-reflectivity can still provide adequate sensitivity for the polarimeter.

To acquire raw data in system 100, the light sources are sequentially cycled through a series of states, with each state comprising one of: one of the light sources turned on, and none of the light sources turned on. During each state, the output signals from the detectors, signals S₁, S₂, S₃, and S₄, are digitized and stored by a processor for further processing. To compensate for ambient background light and electronic signal offsets, the signal intensities acquired with none of the light sources turned on are subtracted from the signal intensities acquired with one of the light sources on. The “background corrected” Raw Data, which may include four signal intensity values at each wavelength, may be subsequently used to calibrate the ellipsometer system, and to acquire ellipsometric data.

Embodiments of the present disclosure may employ a mathematical description of the Polarization State Detector (PSD 150). The interaction of polarized light with optics is commonly modeled using Mueller Matrix and Stokes Vector formalism. A Stokes vector X can represent the polarization state of the incident beam 118 to the PSD 150:

$$X = ( \begin{matrix}{x}_{0} \\ {x}_{1} \\ {x}_{2} \\ {x}_{3}\end{matrix} )$$

The incident beam 118, with polarization state X, interacts with the optical elements (beam splitters and retarders) in the PSD 150, and the resulting beam intensities are measured by the Detectors. The measured detector signals may be packed in a vector Dₘ:

$${D}_{m} = ( \begin{matrix}{S}_{1} \\ {S}_{2} \\ {S}_{3} \\ {S}_{4}\end{matrix} )$$

In the present disclosure, the detector signals are defined as follows: S₁ is from the first detector 504, S₂ is from the second detector 510, S₃ is from the third detector 516, and S₄ is from fourth detector 524. As discussed by Azzam in his original paper on division of amplitude polarimeters (DOAP), systems herein may calculate the resulting measured detector signals Dₘ for a given input polarization state X if the 4×4 Instrument Matrix A is known:

$${D}_{m} = A \cdot X$$

The Instrument Matrix A is a 4×4 matrix, and the rows of A specify the polarization sensitivity of each detector element in Dₘ to the Stokes vector elements X of the incident beam 118. If A is nonsingular, the inverse of A exists (which may be denoted by A⁻¹), and systems herein may determine the Stokes vector elements X of the incident beam 118 from the measured detector intensities Dₘ by the following formula:

$$X = {A}^{- 1} \cdot {D}_{m}$$

Instrument Matrix A can be calculated using the Mueller matrix models of all the optical elements inside the Polarization State Detector (PSD 150), using the following methodology. The Rotation matrix below azimuthally rotates the polarization state by the angle φ. To calculate the Mueller matrix for an optical element with Muller matrix M that is azimuthally rotated by the angle φ about the beam path, pre- and post-multiply the Mueller matrix of the optical element using the following sequence of matrices: Rot(φ)·M·Rot(−φ).

$$Rot ( ψ ) = ( \begin{matrix}1 & 0 & 0 & 0 \\ 0 & cos ( 2 φ ) & - sin ( 2 φ ) & 0 \\ 0 & sin ( 2 φ ) & cos ( 2 φ ) & 0 \\ 0 & 0 & 0 & 1\end{matrix} )$$

The Mueller matrices for glass plate beams splitters in reflection bsR(θ,φ) and transmission bsT(θ,φ) are shown below. In these expressions, the p-polarized reflectivity Rₚ, the s-polarized reflectivity Rₛ, the p-polarized transmission Tₚ, and the s-polarized transmission Tₛ, are calculated using the well-known Fresnel equations, at the angle of incidence θ, as previously shown in FIG. 9. The expressions below also incorporate the azimuthal rotation angle φ of the beam splitter.

$$bsR ( θ , φ ) = Rot ( φ ) \cdot ( \begin{matrix}\frac{{R}_{p} ( θ ) + {R}_{s} ( θ )}{2} & \frac{{R}_{p} ( θ ) - {R}_{s} ( θ )}{2} & 0 & 0 \\ \frac{{R}_{p} ( θ ) - {R}_{s} ( θ )}{2} & \frac{{R}_{p} ( θ ) + {R}_{s} ( θ )}{2} & 0 & 0 \\ 0 & 0 & \sqrt{{R}_{p} ( θ ) \cdot {R}_{s} ( θ )} & 0 \\ 0 & 0 & 0 & \sqrt{{R}_{p} ( θ ) \cdot {R}_{s} ( θ )}\end{matrix} ) \cdot Rot ( - φ )$$

$$bsT ( θ , φ ) = Rot ( φ ) \cdot ( \begin{matrix}\frac{{T}_{p} ( θ ) + {T}_{s} ( θ )}{2} & \frac{{T}_{p} ( θ ) - {T}_{s} ( θ )}{2} & 0 & 0 \\ \frac{{T}_{p} ( θ ) - {T}_{s} ( θ )}{2} & \frac{{T}_{p} ( θ ) + {T}_{s} ( θ )}{2} & 0 & 0 \\ 0 & 0 & \sqrt{{T}_{p} ( θ ) \cdot {T}_{s} ( θ )} & 0 \\ 0 & 0 & 0 & \sqrt{{T}_{p} ( θ ) \cdot {T}_{s} ( θ )}\end{matrix} ) \cdot Rot ( - φ )$$

The Mueller matrix for a retarder Ret(δ, φ) with retardance δ, at the azimuthal rotation angle φ, is shown below. The scalar transmission factor RetT accounts for beam intensity losses, due to partial reflection of the beam from the optic.

$$Ret ( δ , φ ) = RetT \cdot Rot ( φ ) \cdot ( \begin{matrix}1 & 0 & 0 & 0 \\ 0 & 1 & 0 & 0 \\ 0 & 0 & cos ( δ ) & sin ( δ ) \\ 0 & 0 & - sin ( δ ) & cos ( δ )\end{matrix} ) \cdot Rot ( - φ )$$

The vector Di for a detector (where i=1 corresponds to the first detector, i=2 corresponds to the second detector, and so on) which is not polarization sensitive is shown below. The scalar Gain factors Gᵢ are nominally 1, but may be slightly different from 1 to account for variations in detector sensitivity and electronics gain.

$${D}_{i} = {G}_{i} \cdot ( \begin{matrix}1 \\ 0 \\ 0 \\ 0\end{matrix} )$$

The polarization sensitivity vectors pS₁, pS₂, pS₃, and pS₄ for each of the detectors are calculated by multiplying together the Mueller matrices corresponding to the optics in the beam path preceding each detector, as shown below. For example, the first detector 504 only “sees” the reflection of the beam from first beam splitter 502. On the other hand, the fourth detector 524 “sees” the beam transmit through the first, second, and third beam splitters 502, 508, and 514, transmit through the retarder element 520, and then reflect from the fourth beam splitter 522. The rows of the calculated Instrument Matrix A_{calc} are the polarization sensitivity vectors pS₁, pS₂, pS₃, and pS₄.

$${pS}_{1} = bsR ( {θ}_{1} , {φ}_{1} ) \cdot {D}_{1} = ( {pS}_{1 , 1} {pS}_{1 , 2} {pS}_{1 , 3} {pS}_{1 , 4} )$$

$${pS}_{2} = bsT ( {θ}_{1} , {φ}_{1} ) \cdot bsR ( {θ}_{2} , {φ}_{2} ) \cdot {D}_{2} = ( {pS}_{2 , 1} {pS}_{2 , 2} {pS}_{2 , 3} {pS}_{2 , 4} )$$

$${pS}_{3} = bsT ( {θ}_{1} , {φ}_{1} ) \cdot bsT ( {θ}_{2} , {φ}_{2} ) \cdot bsR ( {θ}_{3} , {φ}_{3} ) \cdot {D}_{3} = ( {pS}_{3 , 1} {pS}_{3 , 2} {pS}_{3 , 3} {pS}_{3 , 4} )$$

$${pS}_{4} = bsT ( {θ}_{1} , {φ}_{1} ) \cdot bsT ( {θ}_{2} , {φ}_{2} ) \cdot bsT ( {θ}_{3} , {φ}_{3} ) \cdot Ret ( δ , {φ}_{Ret} ) \cdot bsR ( {θ}_{4} , {φ}_{34} ) \cdot {D}_{4} = ( {pS}_{4 , 1} {pS}_{4 , 2} {pS}_{4 , 3} {pS}_{4 , 4} )$$

$${A}_{calc} = ( \begin{matrix}{pS}_{1 , 1} & {pS}_{1 , 2} & {pS}_{1 , 3} & {pS}_{1 , 4} \\ {pS}_{2 , 1} & {pS}_{2 , 2} & {pS}_{2 , 3} & {pS}_{2 , 4} \\ {pS}_{3 , 1} & {pS}_{3 , 2} & {pS}_{3 , 3} & {pS}_{3 , 4} \\ {pS}_{4 , 1} & {pS}_{4 , 2} & {pS}_{4 , 3} & {pS}_{4 , 4}\end{matrix} )$$

The ability to calculate the Instrument Matrix A_{calc} can be used to evaluate and optimize values for the beam splitter angles of incidence and azimuthal rotations, and the retarder element retardance and azimuthal rotation. For example, using the previously described embodiment, θ₁=38° and φ₁=0° for the first beam splitter 502, θ₂=45° and φ₂=−45° for the second beam splitter 508, θ₃=45° and φ₃=+45° for the third beam splitter 514, and θ₄=57° and φ₄=0° for the fourth beam splitter 522. The retardance of waveplate 520 is 90° and the azimuthal orientation is +45°. Using these values, the calculated Instrument Matrix A_{calc} (normalized such that the first element is 1), and the inverse of the calculated Instrument Matrix A_{calc}⁻¹, are shown below:

$${A}_{calc} = ( \begin{matrix}1.000 & - 0.627 & 0.000 & 0.000 \\ 1.034 & 0.052 & 0.864 & 0.000 \\ 1.008 & 0.051 & - 0.864 & 0.000 \\ 1.163 & 0.059 & 0.000 & - 1.157\end{matrix} )$$

$${A}_{calc}^{- 1} = ( \begin{matrix}0.074 & 0.453 & 0.453 & 0.000 \\ - 1.476 & 0.723 & 0.723 & 0.000 \\ 0.000 & 0.571 & - 0.586 & 0.000 \\ 0.000 & 0.492 & 0.492 & - 0.864\end{matrix} )$$

Accurate operation of a division of amplitudes polarimeter (DOAP) requires an accurate calibration of the Instrument Matrix A. Calibration of the Instrument Matrix A may be typically done with a PSG 110 which includes a rotatable polarizer 460 and a rotatable retarder 114 (“Accurate calibration of the four-detector photopolarimeter with imperfect polarizing optical elements”, R. M. A. Azzam and Ali G. Lopez, J. Opt. Soc. Am. A Vol. 6, No. 10, page 1513, 1989). The present disclosure utilizes a similar approach, but it has been modified and extended to accommodate non-idealities which may exist in the present disclosure hardware. The PSG 110 hardware for the present disclosure was described previously, and includes a rotatable polarizer 465 mechanism. For an ideal polarizer at azimuthal rotation angle P, the Stokes vector PSG(P)_{Ideal} which exits the PSG 110 is shown below.

$${PSG ( P )}_{Ideal} = Rot ( P ) \cdot \frac{1}{2} ( \begin{matrix}1 & 1 & 0 & 0 \\ 1 & 1 & 0 & 0 \\ 0 & 0 & 0 & 0 \\ 0 & 0 & 0 & 0\end{matrix} ) \cdot Rot ( - P ) \cdot ( \begin{matrix}1 \\ 0 \\ 0 \\ 0\end{matrix} ) = ( \begin{matrix}1 \\ cos ( 2 P ) \\ sin ( 2 P ) \\ 0\end{matrix} )$$

In an embodiment of the present disclosure, the Stokes vector PSG(P) at the polarizer azimuthal rotation angle P which exits the PSG 110 may be given by the Stokes vector below. This Stokes vector may account for various non-idealities, such as incomplete extinction of the polarizer, residual ellipticity in the polarizer, and birefringence in any optic between the PSG 110 and the Sample 202. The non-ideality terms n₀, n₁, n₂, n₃, n₄, and n₅ may be determined by the calibration procedure described next.

$$PSG ( P ) = ( \begin{matrix}1 \\ cos ( 2 P ) \cdot ( 1 - {n}_{0} ) + {n}_{1} cos ( 4 P ) + {n}_{2} sin ( 4 P ) \\ sin ( 2 P ) \cdot ( 1 - {n}_{0} ) - {n}_{1} sin ( 4 P ) + {n}_{2} cos ( 4 P ) \\ {n}_{3} + {n}_{4} cos ( 2 P ) + {n}_{5} sin ( 2 P )\end{matrix} )$$

For the instrument matrix calibration procedure, system 100 may be configured in the straight-through mode, which was previously described and is shown in FIG. 1. A waveplate 114 and waveplate rotator 112 may be added to the beam path for part of the instrument matrix calibration procedure (though any retardation inducing element may be used in place of the waveplate). When the waveplate is present in the beam path, the following Mueller matrix sequence WP_{MM}(φ_{WP}, δ_{WP}, rp_{WP}) may be multiplied times the PSG(P) Stokes vector to calculate the Stokes vector of the beam which exits the waveplate and enters the PSD 150.

$${WP}_{MM} ( {φ}_{WP} , {δ}_{WP} , {rp}_{WP} ) = Rot ( {rp}_{WP} ) \cdot Rot ( {φ}_{WP} ) \cdot ( \begin{matrix}1 & 0 & 0 & 0 \\ 0 & 1 & 0 & 0 \\ 0 & 0 & cos ( {δ}_{WP} ) & sin ( {δ}_{WP} ) \\ 0 & 0 & - sin ( {δ}_{WP} ) & cos ( {δ}_{WP} )\end{matrix} ) \cdot Rot ( - {φ}_{WP} )$$

The WP_{MM}(φ_{WP}, δ_{WP}, rp_{WP}) Mueller matrix function models the polarization properties of a waveplate which may be azimuthally oriented at φ_{wp}, with a retardance value of δ_{WP}, and a rotary power of rp_{WP}. Given the Stokes vector output from the PSG 110, the Mueller matrix function for the waveplate, and the 4×4 instrument matrix A (with elements a₀₀, a₀₁, a₀₂, a₀₃, a₁₀, a₁₁, a₁₂, a₁₃, a₂₀, a₂₁, a₂₂, a₂₃, a₃₀, a₃₁, a₃₂, and a₃₃) which characterizes the polarization properties of the PSD 150, systems herein may calculate detector signal values C₁, C₂, C₃, and C₄ using the formula below.

$${D}_{c} = ( \begin{matrix}{C}_{1} \\ {C}_{2} \\ {C}_{3} \\ {C}_{4}\end{matrix} ) = A \cdot {WP}_{MM} ( {φ}_{WP} , {δ}_{WP} , {rp}_{WP} ) \cdot PSG ( P ) = ( \begin{matrix}{a}_{00} & {a}_{01} & {a}_{02} & {a}_{03} \\ {a}_{10} & {a}_{11} & {a}_{12} & {a}_{13} \\ {a}_{20} & {a}_{21} & {a}_{22} & {a}_{23} \\ {a}_{30} & {a}_{31} & {a}_{32} & {a}_{33}\end{matrix} ) \cdot {WP}_{MM} ( {φ}_{WP} , {δ}_{WP} , {rp}_{WP} ) \cdot PSG ( P )$$

Thus completes the “forward calculation” of the detector signal values C₁, C₂, C₃, and C₄, which may be performed at any specified values of P, no, n₁, n₂, n₃, n₄, n₅, φ_{WP}, δ_{WP}, rp_{WP} and instrument matrix A elements doo, a₀₁, a₀₂, a₀₃, a₁₀, a₁₁, a₁₂, a₁₃, a₂₀, a₂₁, a₂₂, a₂₃, a₃₀, a₃₁, a₃₂, and a₃₃.

To calibrate the 4×4 instrument matrix A of the present disclosure, system 100 may be first placed in a straight through mode, which was previously described and is shown in FIG. 1. The waveplate and waveplate rotator may be inserted into the beam path between the PSG 110 and PSD 150. The calibration waveplate may be azimuthally rotated to multiple orientations. At each calibration waveplate orientation, the polarizer optic in the PSG 110 may be azimuthally rotated to multiple orientations. At each combination of polarizer and waveplate azimuths, system 100 may acquire and store raw data at each wavelength, as previously described.

The calibration waveplate may be removed from the beam path. System 100 may azimuthally rotate the polarizer optic again to multiple orientations, and acquire and store the raw data (comprising signals S₁, S₂, S₃, and S₄, as previously defined) at each azimuthal orientation. In one embodiment, 4 azimuthal angles are used for the calibration waveplate (−67.5°, −22.5°, 22.5°, and) 67.5°, and 8 azimuthal angles are used for the polarizer optic (0.90°, −67.5°, −45°, −22.5°, 0°, +22.5°, and +45) This results in a Calibration Data Set with (4+1)·8=40 raw data points acquired at each wavelength, and each raw data point contains 4 detector signals, for a total of 4.40=160 data values at each wavelength. The Calibration Data Sets are denoted signals S_{1,i}, S_{2,i}, S_{3,i}, and S_{4,i}, where i ranges from 1 to 40, and separate Calibration Data Sets are acquired and stored at each wavelength of the PSG 110. To eliminate the effect of light source intensity fluctuations, both the measured and calculated Calibration Data Sets may be normalized by the average of the signal values measured (or calculated) by the 4 detectors:

$${s}_{ave , i} = \frac{{S}_{1 , i} + {S}_{2 , i} + {S}_{3 , i} + {S}_{4 , i}}{4} {S}_{1 n , i} = \frac{{S}_{1 , i}}{{S}_{a v e ,}} {S}_{2 n , i} = \frac{{S}_{2 , i}}{{S}_{a ve , i}} {S}_{3 n , i} = \frac{{S}_{3 , i}}{{S}_{a ve , i}}$$

$${S}_{4 n , i} = \frac{{S}_{4 , i}}{{S}_{a ve , i}}$$

$${C}_{ave , i} = \frac{{C}_{1 , i} + {C}_{2 , i} + {C}_{3 , i} + {C}_{4 , i}}{4} {C}_{1 n , i} = \frac{{C}_{1 , i}}{{C}_{a ve , i}} {C}_{2 n , i} = \frac{{C}_{2 , i}}{{C}_{a ve , i}} {C}_{3 n , i} = \frac{{C}_{3 , i}}{{C}_{a ve , i}}$$

$${C}_{4 n , i} = \frac{{C}_{4 , i}}{{C}_{a ve , i}}$$

To determine the calibration values of interest (most importantly, the 16 elements of the 4×4 Instrument Matrix A) given the acquired Calibration Data Set, the present disclosure utilizes a model-based, least squares, non-linear regression analysis of the data set. This is the same conceptual approach that is typically used to analyze ellipsometric data, and it has also been applied to the calibration of rotating element ellipsometer systems. See B. Johs, Regression calibration method for rotating element ellipsometers, THIN SOLID FILMS, 234, 395 (1993); U.S. Pat. No. 5,872,630 to Johs et al. (both of which are incorporated by reference herein in their entirety). This analysis approach may acquire a data set, construct a parameterized model which may calculate data corresponding to the acquired data, define a least squares metric to quantify the difference between the acquired data and the model calculated data, and a regression algorithm may be employed to iteratively adjust (or “fit”) the model parameters to minimize the least squares metric. For the present disclosure, the least squares metric χ² may be written as:

$${χ}^{2} = {\sum }_{i = 1}^{40} [ {( {S}_{1 n , i} - {C}_{1 n , i} )}^{2} + {( {S}_{2 n , i} - {C}_{2 n , i} )}^{2} + {( {S}_{3 n , i} - {C}_{3 n , i} )}^{2} + {( {S}_{4 n , i} - {C}_{4 n , i} )}^{2} ]$$

The acquisition of Calibration Data set S_{1n,i}, S_{2n,i}, S_{3n,i}, and S_{4n,i} was previously described, as was the model used to calculate data C_{1n,i}, C_{2n,i}, C_{3n,i}, and C_{4n,i} (with the subscript i indexing the values of P and φ_{WP} used in the calculation which correspond to the azimuthal orientations of the PSG 110 Polarizer and Calibration Waveplate for the i'th data point). A well-known non-linear regression algorithm for minimizing the least squares metric χ² is the Levenberg-Marquardt algorithm. Public domain code implementations of the Levenberg-Marquardt algorithm are also available, for example: https://jugit.fz-juelich.de/mlz/lmfit/. In the present disclosure, the Levenberg-Marquardt algorithm may be used to simultaneously determine (or “fit”) the model parameters by a non-linear regression fit of the 160 point Calibration Data Set.

The model fit parameters are: P₁, P₂, P₃, P₄, P₅, P₆, P₇, and P₈ (azimuthal angles of the 8 orientations of the rotatable polarizer mechanism in the PSG 110), no, n₁, n₂, n₃, n₄, n₅ (PSG non-ideality terms), φ_{WP1}, φ_{WP2}, φ_{WP3}, and φ_{WP4} (the azimuthal angles of the calibration waveplate in the waveplate rotator), δ_{WP} (the retardance of the calibration waveplate), rp_{WP} (the rotary power of the calibration waveplate) and 15 of the 4×4 instrument matrix A elements a₀₁, a₀₂, a₀₃, a₁₀, a₁₁, a₁₂, a₁₃, a₂₀, a₂₁, a₂₂, a₂₃, a₃₀, a₃₁, a₃₂, and a₃₃ (a₀₀ is fixed at 1 as the data sets are normalized).

The large 160 point Calibration Data Set includes many combinations of PSG 110 Polarizer and calibration waveplate azimuthal angles, which in turn generates a range of polarization states in the beam which enters the PSD 150, and thereby overdetermines the 35 fit parameters in the model. This enables the simultaneous and accurate determination of the Instrument Matrix A elements, along with all the characterizing parameters for the PSG 110 and calibration waveplate.

Since the azimuthal angles are determined in the regression fit, the polarizer and waveplate azimuthal rotation mechanisms do not have to be accurate, though they do still need to be reproducible. Fitting for the polarizer non-ideality terms enables the use of low cost plastic polarizers. Likewise, the retardance and rotary power of the calibration waveplate do not need to be accurately known, as they are determined as part of the instrument matrix calibration procedure. In the present disclosure, the regression fit may be performed using Calibration Data Sets acquired at each wavelength, and all the resulting parameters from the calibration at each wavelength are stored for use in subsequent calibrations and ellipsometric data acquisition.

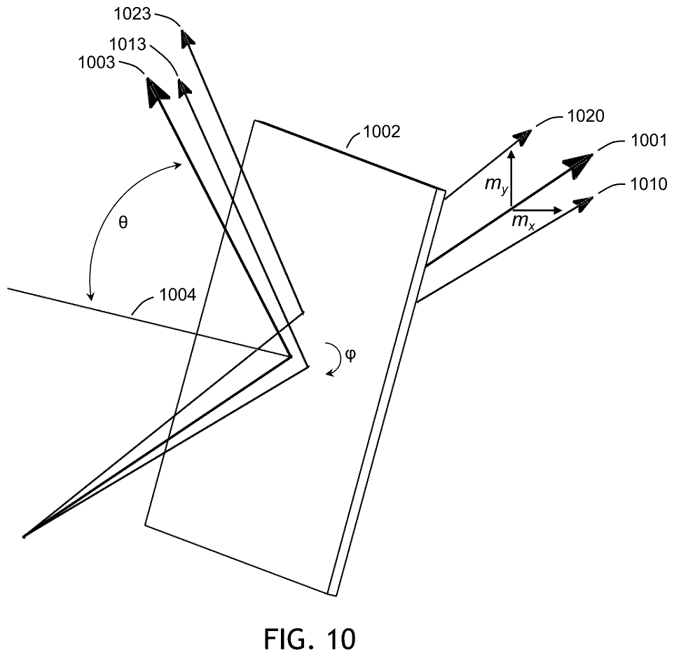

Consider a misalignment of the beam 118 input to the PSD 150, which may typically occur when operating in the in situ mode shown in FIG. 3. In this case, the beam angles to the PSD internal beamsplitters will be different from the nominal values, and therefore the Instrument Matrix A may change due to the input beam misalignment. A schematic representation of beam misalignment with respect to a beamsplitter is shown in FIG. 10. Beam 1001 is the nominally aligned beam, which transmits through beam splitter 1002, and is partially reflected into beam 1003. The angle of incidence θ is defined between the reflected beam 1003 and the surface normal of the beam splitter 1004. The azimuthal rotation of the beamsplitter (about the beam axis 1001) is defined by φ. A misaligned beam 1010 is shown, wherein the beam is misaligned “to the right” by the angle mₓ. Misaligned beam 1010 partially reflects from beamsplitter 1002 into beam 1013. A misaligned beam 1020 is also shown, wherein the beam is misaligned “up” by the angle m_{y}. Misaligned beam 1020 partially reflects from beamsplitter 1002 into beam 1023. The beam misalignment angles mₓ and m_{y} will change the beamsplitter angle of incidence θ and azimuthal rotation angle φ according to the equations below, which can be derived using 3D trigonometry with small angle approximations.

$${θ}_{m} = a cos ( cos ( θ ) - {m}_{x} sin ( θ ) sin ( φ ) - {m}_{y} sin ( θ ) cos ( φ ) )$$

$${φ}_{m} = a tan 2 ( sin ( θ ) sin ( φ ) + {m}_{x} cos ( θ ) , sin ( θ ) cos ( φ ) + {m}_{y} cos ( θ ) )$$

The above equations, combined with the previously described Mueller Matrix model for the PSD 150, can be used to calculate correction factors for the Instrument Matrix A in the presence of beam misalignment, using the following procedure. First determine a Nominal Calculated Instrument Matrix A_{NomCalc}, which best matches the Instrument Matrix A determined from the calibration procedure described above. This may be done by a non-linear regression fit to minimize the difference between the elements in A_{NomCalc} and A, with the beamsplitter angles of incidence and azimuthal rotation angles, retarder retardance and azimuthal rotation angles, and detector Gain factors as fitting parameters. Next, calculate a Misaligned X Calculated Instrument Matrix A_{MxCalc}, by assuming a small value δ (such as) 0.5° for mₓ, transforming the beamsplitter angles incidence and azimuthal rotation angles using the above beam misalignment equations with mₓ=δ, and evaluating the Mueller Matrix model of the PSD with the transformed beamsplitter angles. In a similar manner, calculate a Misaligned Y Calculated Instrument Matrix A_{MyCalc} with m_{y}=δ. Then, for beam misalignment angles mₓ and m_{y} (which may be determined by the position sensitive detector 530), a corrected Instrument Matrix A_{Corr} can be calculated as shown below. To improve the ellipsometric measurement accuracy, A_{Corr} can be used in place of the Instrument Calibration Matrix A for subsequent calibrations and measurements.

$${A}_{Corr} = A + \frac{{m}_{x}}{δ} ( {A}_{MxCalc} - {A}_{NomCalc} ) + \frac{{m}_{y}}{δ} ( {A}_{MyCalc} - {A}_{NomCalc} )$$

System 100 may employ an Off-Sample calibration before system 100 may acquire ellipsometric data from a sample. The Off-Sample calibration determines the azimuthal offsets of the PSG 110 and PSD 150 units with respect to the sample plane of incidence. In the Off-Sample calibration procedure, system 100 may be first configured in the Off-Sample mode, as previously described and shown in FIG. 2. Next, a sample 202 may be mounted and optionally aligned, as was previously described. System 100 may acquire an off sample calibration data set by acquiring raw data at multiple azimuthal orientations of the polarizer in the PSG 110, which in one embodiment includes 8 angles (−90°, −67.5°, −45°, −22.5°, 0°, +22.5°, and +45). To analyze the off sample calibration data set, a Levenberg-Marquardt non-linear regression analysis of the off-sample calibration data set may be performed, using the calculation model shown below.

$$( \begin{matrix}{C}_{1} \\ {C}_{2} \\ {C}_{3} \\ {C}_{4}\end{matrix} ) = A \cdot Rot ( {rot}_{PSD} ) \cdot Sample \cdot Rot ( {rot}_{PSG} ) \cdot PSG ( P ) = A \cdot Rot ( {rot}_{PSD} ) \cdot ( \begin{matrix}1 & - N & 0 & 0 \\ - N & 1 & 0 & 0 \\ 0 & 0 & C & S \\ 0 & 0 & - S & C\end{matrix} ) \cdot Rot ( {rot}_{PSG} ) \cdot PSG ( P )$$

In the off sample regression analysis, all the parameters in the 4×4 instrument matrix A and PSG 110 Stokes vector PSG(P) are fixed at the values determined in the instrument matrix calibration procedure. For the off sample calibration analysis, the model fit parameters are: rot_{PSG} (the azimuthal offset of the PSG 110 unit), rot_{PSD} (the azimuthal offset of the PSD 150 unit), and the sample 202 ellipsometric parameters N, C, and S, which are defined in terms of the traditional ellipsometric parameters and Δ by N=cos(2Ψ), C=sin(2Ψ)cos(Δ), and S=sin(2Ψ)sin(Δ). Since the values for rot_{PSG} and rot_{PSD} should be independent of wavelength, the regression analysis simultaneously includes the calibration data sets from all the wavelengths. In one embodiment, the total number of data points in the analysis may be 256 (raw data acquired at 8 orientations of the polarizer, times 4 signals in each raw data point, times 8 wavelengths). The total number of fit parameters may be 26 (2 azimuthal rotation angles for the PSG 110 and PSD 150, plus 3 ellipsometric parameters N, C, and S at 8 wavelengths). Therefore, the fit may be overdetermined (that is, there are more data points than fit parameters), and the 2 off sample calibration parameters, rot_{PSG} and rot_{PSD}, may be simultaneously and accurately determined along with the sample 202 ellipsometric parameters N, C, and S at all wavelengths. To exclude the effects of light source intensity and sample 202 reflectivity from the analysis, the acquired off sample Calibration Data Set and the corresponding Calculated Data Sets may be normalized by their average values in the analysis. The off sample calibration parameters rot_{PSG} and rot_{PSD} are stored for subsequent use in ellipsometric data acquisition.

To acquire ellipsometric data with the present disclosure, the following steps are performed. First system 100 may be configured in the off sample mode, as previously described and shown in FIG. 2. Next, a sample 202 may be mounted and optionally aligned, as described above. The polarizer mechanism in the PSG 110 may be adjusted to orient the polarizer in the data acquisition position, which in one embodiment may be +45°.

System 100 may acquire raw data, comprising signals S₁, S₂, S₃, and S₄, at each wavelength. System 100 may determine ellipsometric parameters from the raw data signals, using the equations below. The Mueller matrix expression below calculates the signals S₁, S₂, S₃, and S₄, using the Stokes vector of the light generated by the PSG 110, the azimuthal rotation angle of the PSG 110, the unnormalized ellipsometric parameters of the sample 202 (indicated by the parameters primed), the azimuthal rotation angle of the PSD 150, and the instrument matrix A. In this expression, the only unknown parameters are I (which may be related to the intensity of the light reflected from the sample 202), and the unnormalized ellipsometric parameters N′, C′, and S′. The signals S₁, S₂, S₃, and S₄ are measured, and the other parameters were previously determined in the instrument and off sample calibration.

$$( \begin{matrix}{S}_{1} \\ {S}_{2} \\ {S}_{3} \\ {S}_{4}\end{matrix} ) = A \cdot Rot ( {rot}_{P S D} ) \cdot ( \begin{matrix}I & - {N}^{′} & 0 & 0 \\ - {N}^{′} & I & 0 & 0 \\ 0 & 0 & {C}^{′} & {S}^{′} \\ 0 & 0 & - {S}^{′} & {C}^{′}\end{matrix} ) \cdot Rot ( {rot}_{PSG} ) \cdot PSG ( P )$$

Systems herein may calculate the Stokes vector elements of the light incidence on the sample 202, IS, using the expression below.

$$IS = ( \begin{matrix}i {s}_{0} \\ i {s}_{1} \\ i {s}_{2} \\ i {s}_{3}\end{matrix} ) = R o t ( r o {t}_{P S G} ) \cdot PSG ( P )$$

The Stokes vector of the light entering the PSD 150, X, may be written as in the expression below.

$$X = ( \begin{matrix}{x}_{0} \\ {x}_{1} \\ {x}_{2} \\ {x}_{3}\end{matrix} ) = Rot ( {rot}_{P S D} ) \cdot ( \begin{matrix}I & - {N}^{′} & 0 & 0 \\ - {N}^{′} & I & 0 & 0 \\ 0 & 0 & {C}^{′} & {S}^{′} \\ 0 & 0 & - {S}^{′} & {C}^{′}\end{matrix} ) \cdot IS = ( \begin{matrix}I & - {N}^{′} & 0 & 0 \\ - {N}^{′} \cdot {C}_{rotPSD} & I \cdot {C}_{rotPSD} & - {C}^{′} \cdot {S}_{rotPSD} & - {S}^{′} \cdot {S}_{rotPSD} \\ - {N}^{′} \cdot {S}_{rotPSD} & I \cdot {S}_{rotPSD} & {C}^{′} \cdot {S}_{rotPSD} & {S}^{′} \cdot {S}_{rotPSD} \\ 0 & 0 & - {S}^{′} & {C}^{′}\end{matrix} ) \cdot IS$$

with C_{rotPSD}=cos (rot_{PSD}) and S_{rotPSD}=sin (rot_{PSD})

Systems herein may calculate the values of the elements of X, x₀, x₁, x₂, and x₃, using the measured signal values S₁, S₂, S₃, and S₄, and the inverse of the instrument matrix A⁻¹ (this is the fundamental equation of a DOAP, as was previously described).

$$X = ( \begin{matrix}{x}_{0} \\ {x}_{1} \\ {x}_{2} \\ {x}_{3}\end{matrix} ) = {A}^{- 1} \cdot ( \begin{matrix}S 1 \\ S 2 \\ S 3 \\ S 4\end{matrix} )$$

Since the elements of X and IS are now known, the unnormalized ellipsometric parameters may be solved from system 100 of equations relating X and IS, resulting in the following expressions:

$$I = \frac{{x}_{0} \cdot {is}_{0} - ( {x}_{1} \cdot {C}_{rotPSD} + {x}_{2} \cdot {S}_{rotPSD} ) \cdot {is}_{1}}{i {s}_{0}^{2} - i {s}_{1}^{2}}$$

$${N}^{′} = \frac{{x}_{0} \cdot {is}_{1} - ( {x}_{1} \cdot {C}_{rotPSD} + {x}_{2} \cdot {S}_{rotPSD} ) \cdot {is}_{0}}{i {s}_{0}^{2} - i {s}_{1}^{2}}$$

$${C}^{′} = \frac{{x}_{3} \cdot {is}_{3} + ( {x}_{2} \cdot {C}_{rotPSD} - {x}_{1} \cdot {S}_{rotPSD} ) \cdot {is}_{2}}{i {s}_{2}^{2} + {is}_{3}^{2}}$$

$${S}^{′} = \frac{- {x}_{3} \cdot {is}_{2} + ( {x}_{2} \cdot {C}_{rotPSD} - {x}_{1} \cdot {S}_{rotPSD} ) \cdot {is}_{3}}{i {s}_{2}^{2} + {is}_{3}^{2}}$$

Systems herein may calculate ellipsometric parameters by the following expressions, wherein the a tan 2( ) function is the commonly used programming function which takes two arguments and returns angle in the correct quadrant, and P stands for degree of polarization, which is equal to 1 if the sample 202 does not depolarize the beam, and may be less than 1 if the sample 202 does depolarize the beam.

$$N = \frac{{N}^{′}}{I} C = \frac{{C}^{′}}{I} S = \frac{{S}^{′}}{I}$$

$$Ψ = \frac{1}{2} a tan ( \frac{\sqrt{{C}^{2} + {S}^{2}}}{N} ) Δ = a tan 2 ( S , C )$$

$$P = \sqrt{{N}^{2} + {C}^{2} + {S}^{2}}$$

In the present disclosure, the preceding formulas are applied to the raw data signals acquired at each wavelength, and the calculated ellipsometric parameters are displayed and/or stored for further processing.

It is well-known that windows and lenses which are in the beam path of an ellipsometer system may affect the accuracy of the ellipsometric data acquired by the system. See G.E. Jellison, Jr., Windows in ellipsometry measurements, APPLIED OPTICS, 38, 4784 (1999) (explaining that windows or lenses which are in the beam path of an ellipsometer system can affect the accuracy of the ellipsometric data acquired by the system) (incorporated by reference herein in its entirety). Any small stress on glass components, which is often due to the mounting mechanism of the component, can induce birefringence in the component, which in turn can modify the polarization state of a beam which transmits through the component. Windows are used to provide optical access for the ellipsometer beam to allow measurements on a sample 202 inside a chamber 372, as drawn and previously discussed in FIG. 3. Lenses may be added to the beam path to reduce the spot size of the beam on the sample 202, as drawn and previously discussed in FIG. 2.

In the following discussion, the term “windows” may be used, but it may be understood that the same comments may be equivalently applied to “lenses” as well. It is well-known that three parameters are desired to accurately characterize the effects of two windows in the ellipsometer beam path (one window between the PSG 110 and sample 202, and the second window between the sample 202 and PSD 150). However, it is also well-known that even with an ellipsometer system that may measure the full Mueller matrix of a sample 202; it may not be possible to independently determine all three window parameters. In attempts to overcome this limitation, Jellison suggests the windows need to be measured separately before the windows are installed on the chamber. This approach is not only inconvenient, but it may also limit the accuracy of the window characterization, as the process of mounting the windows on the chamber may induce or change the stress on the window, resulting in polarization properties which are different from those measured before the installation of the window.

To overcome this limitation, system 100 may: 1) separately measure a reference sample 202 outside the chamber 372 without windows in the beam path to determine the optical model for the reference sample 202, 2) mount the reference sample 202 inside the chamber 372, 3) perform a windows correction procedure, using the previously determined optical model for the reference sample 202, to determine the angle of incidence of the beam with respect to the sample 202 inside the change and the three window calibration parameters (at each wavelength in the ellipsometer system), and then, 4) acquire accurate ellipsometric data using the three window calibration parameters to correct for the polarization effects of the windows present in the ellipsometer beam path. The derivation of the window correction procedure of uses the following notation. The Mueller matrix M_{W}, derived to the first order, for a window with a small retardation δ which may be oriented at an angle θ, is shown below.

$${M}_{W} = ( \begin{matrix}1 & 0 & 0 & 0 \\ 0 & 1 & 0 & - {S}_{W} \\ 0 & 0 & 1 & {C}_{W} \\ 0 & {S}_{W} & - {C}_{W} & 1\end{matrix} ) {C}_{W} = δ cos ( θ ) {S}_{W} = δ sin ( θ )$$

If windows are placed before and after the sample 202 in the beam path, the resulting Mueller matrix expression M_{SampWin} is:

$${M}_{SampWin} = {M}_{W 1} \cdot Samp \cdot {M}_{W 0} = ( \begin{matrix}1 & 0 & 0 & 0 \\ 0 & 1 & 0 & - {S}_{1} \\ 0 & 0 & 1 & {C}_{1} \\ 0 & {S}_{1} & - {C}_{1} & 1\end{matrix} ) \cdot ( \begin{matrix}1 & - N & 0 & 0 \\ - N & 1 & 0 & 0 \\ 0 & 0 & C & S \\ 0 & 0 & - S & C\end{matrix} ) \cdot ( \begin{matrix}1 & 0 & 0 & 0 \\ 0 & 1 & 0 & - {S}_{0} \\ 0 & 0 & 1 & {C}_{0} \\ 0 & {S}_{0} & - {C}_{0} & 1\end{matrix} ) = ( \begin{matrix}1 & - N & 0 & {S}_{0} \cdot N \\ - N & 1 & {S}_{1} \cdot S & - {S}_{0} - {S}_{1} \cdot C \\ 0 & {S}_{0} \cdot S & C - W \cdot S & S + W \cdot C \\ - {S}_{1} \cdot N & {S}_{1} + {S}_{0} \cdot C & - ( S + W \cdot C ) & C - W \cdot S\end{matrix} )$$

$${S}_{0} = {δ}_{0} sin ( {θ}_{0} ) {S}_{1} = {δ}_{1} sin ( {θ}_{1} ) W = {δ}_{0} cos ( {θ}_{0} ) + {δ}_{1} sin ( {θ}_{1} )$$

In the above expression for M_{SampWin}, note that the sample ellipsometric parameter N is not affected by the windows (at least to the first order), while the W window parameter, which may be a sum of components from the windows, combines indistinguishably with the sample's C and S ellipsometric parameters.

A first step in the window correction procedure may be to ellipsometrically measure and analyze a reference sample 202, without windows in the beam path. The result of the analysis is an optical model which represents the sample 202, and with this optical model, systems herein may calculate ellipsometric parameters N, C, and S for any angle of incidence.

A second step of the window correction procedure may be to determine elements of the M_{SampWin} matrix. This may be done by mounting the previously measured and analyzed reference sample 202 in the chamber 372, with the windows in the beam path. System 100 may acquire a windows calibration data set, using multiple orientations of the polarizer in the PSG 110. In one embodiment, system 100 may acquire and store raw data at 8 polarizer azimuthal angles of −90°, −67.5°, −45°, −22.5°, 0°, +22.5°, and +45°. To analyze the window calibration data set, a Levenberg-Marquardt non-linear regression analysis of the window calibration data set may be performed, using the calculation model shown below.

$$( \begin{matrix}{C}_{1} \\ {C}_{2} \\ {C}_{3} \\ {C}_{4}\end{matrix} ) = A \cdot Rot ( {rot}_{PSD} ) \cdot {M}_{SampWin} \cdot Rot ( {rot}_{PSG} ) \cdot PSG ( P ) = A \cdot Rot ( {rot}_{PSD} ) \cdot ( \begin{matrix}1 & a & 0 & 0 \\ a & 1 & b & 0 \\ 0 & c & d & e \\ f & g & - e & d\end{matrix} ) \cdot Rot ( {rot}_{PSG} ) \cdot PSG ( P )$$

In the calculation model above, elements in the M_{SampWin} matrix have been replaced with parameters a, b, c, d, e, f, and g. In the window calibration regression analysis, all the parameters in the 4×4 instrument matrix A and PSG 110 Stokes vector PSG(P) are fixed at the values determined in the instrument matrix calibration procedure. For the window calibration analysis, the model fit parameters are: rot_{PSG} (the azimuthal offset of the PSG 110 unit), rot_{PSD} (the azimuthal offset of the PSD 150 unit), and the Mueller matrix elements of the M_{SampWin} matrix a, b, c, d, e, f, and g. Since the values for rot_{PSG} and rot_{PSD} should be independent of wavelength, the regression analysis simultaneously includes the calibration data sets from all the wavelengths. In one embodiment, the total number of data points in the analysis may be 256 (raw data acquired at 8 orientations of the polarizer, times 4 signals in each raw data point, times 8 wavelengths). The total number of fit parameters may be 58 (2 azimuthal rotation angles for the PSG 110 and PSD 150, plus 7 M_{SampWin} matrix elements at 8 wavelengths). Therefore, the fit is overdetermined, and the 2 off sample calibration parameters, rot_{PSG} and rot_{PSD}, may be simultaneously and accurately determined along with the M_{SampWin} matrix elements at all wavelengths. To exclude the effects of light source intensity and sample 202 reflectivity from the analysis, the acquired Window Calibration Data Set and the corresponding Calculated Data Sets are normalized by their average values in the analysis.

A third step in the window correction procedure is to determine the angle of incidence of the beam with respect to the reference sample. From the Window Calibration analysis, the ellipsometric parameter N may be now known at each wavelength, as N=−a. The N values at each wavelength now serve as an Angle Determination Data Set. The optical model for the reference sample 202, determined in the first step of the window correction procedure, may be used to calculate values of N vs. angle of incidence. The angle of incidence may be the only fit parameter in the Angle Determination analysis. Systems herein may determine the angle of incidence via a well-known Levenberg-Marquardt non-linear regression analysis of the Angle Determination Data Set using the optical model for the reference sample 202 which was determined in step one. Once system 100 determines the angle of incidence, system 100 may calculate the ellipsometric parameters for the reference sample 202 N, C, and S at each wavelength, and these values will be used in the next step of the window correction procedure.

A fourth step in the window correction procedure is to determine the window correction parameters, which may be also done using non-linear regression analysis. The data sets for this analysis are the Mueller matrix elements determined in the Window Calibration analysis. The calculation model may be specified by the original definition of the M_{SampWin} matrix, as shown below. The N, C, and S parameters are fixed at values calculated from the optical model determined in the Angle Determination analysis, and the fitting parameters are the window parameters S₀, S₁, and W.

$$b = {S}_{1} \cdot S c = {S}_{0} \cdot S d = C - W \cdot S$$

$$f = - {S}_{1} \cdot N g = {S}_{1} + {S}_{0} \cdot C e = S + W \cdot C$$

System 100 may perform a Levenberg-Marquardt non-linear regression analysis separately at each wavelength, resulting in the window parameters S₀, S₁, and W at each wavelength, which are stored and used as correction factors when acquiring subsequent ellipsometric data sets.

The next step in the window correction procedure is to acquire accurate ellipsometric data on samples, with windows in the beam path, using the previously determined window parameters as correction factors. The window correction procedure for acquiring accurate ellipsometric data with windows in the beam path may be derived as follows. The Stokes vector IS of light incident on the sample 202, after passing through the first window, is given by:

$$IS = ( \begin{matrix}i {s}_{0} \\ i {s}_{1} \\ i {s}_{2} \\ i {s}_{3}\end{matrix} ) = Rot ( {rot}_{P S G} ) \cdot ( \begin{matrix}1 & 0 & 0 & 0 \\ 0 & 1 & 0 & - {S}_{0} \\ 0 & 0 & 1 & W \\ 0 & {S}_{0} & - W & 1\end{matrix} ) \cdot PSG ( P )$$

In the above expression, systems herein may calculate the Stokes vector from the PSG 110 using values previously determined in the instrument matrix calibration procedure, and the rot_{PSG}, S₀, and W values were previously determined in the window correction procedure. The Mueller matrix expression that may be used to calculate the intensity signals measured by the detectors S1, S2, S3, and S4 is:

$$( \begin{matrix}S 1 \\ S 2 \\ S 3 \\ S 4\end{matrix} ) = A \cdot {M}_{W 1} \cdot Rot ( r o {t}_{P S D} ) \cdot Samp \cdot IS = A \cdot ( \begin{matrix}1 & 0 & 0 & 0 \\ 0 & 1 & 0 & - {S}_{1} \\ 0 & 0 & 1 & 0 \\ 0 & {S}_{1} & 0 & 1\end{matrix} ) \cdot Rot ( {rot}_{P S D} ) \cdot ( \begin{matrix}I & - {N}^{′} & 0 & 0 \\ - {N}^{′} & I & 0 & 0 \\ 0 & 0 & {C}^{′} & {S}^{′} \\ 0 & 0 & - {S}^{′} & {C}^{′}\end{matrix} ) \cdot IS$$

Pre-multiplying each side of the preceding expression by

$${Rot ( {rot}_{P S D} )}^{- 1} \cdot {M}_{W 1}^{- 1} .$$

A⁻¹ yields:

$${Rot ( {rot}_{PSD} )}^{- 1} \cdot {M}_{W 1}^{- 1} \cdot {A}^{- 1} \cdot ( \begin{matrix}S 1 \\ S 2 \\ S 3 \\ S 4\end{matrix} ) = X = ( \begin{matrix}I & - {N}^{′} & 0 & 0 \\ - {N}^{′} & I & 0 & 0 \\ 0 & 0 & {C}^{′} & {S}^{′} \\ 0 & 0 & - {S}^{′} & {C}^{′}\end{matrix} ) \cdot IS$$

$$X = ( \begin{matrix}{x}_{0} \\ {x}_{1} \\ {x}_{2} \\ {x}_{3}\end{matrix} ) = Rot ( - {rot}_{PSD} ) \cdot ( \begin{matrix}1 & 0 & 0 & 0 \\ 0 & \frac{1}{{S}_{1}^{2} + 1} & 0 & \frac{{S}_{1}}{{S}_{1}^{2} + 1} \\ 0 & 0 & 1 & 0 \\ 0 & - \frac{{S}_{1}}{{S}_{1}^{2} + 1} & 0 & \frac{1}{{S}_{1}^{2} + 1}\end{matrix} ) \cdot {A}^{- 1}$$

The above expression calculates the Stoke vector X, which is for the beam immediately after reflecting from the sample 202, in terms of the inverse of the instrument matrix A⁻¹, the inverse of the matrix for the second window M_{W1}⁻¹, and the inverse of the rotation matrix for the detector, using the identity Rot(x)⁻¹=Rot(−x). Having computed the elements of the X and IS Stokes vectors x₀, x₁, x₂, x₃, is₀, is₁, is₂, and is₃, systems herein may calculate the unnormalized ellipsometric values for the sample 202 by:

$$I = \frac{{x}_{0} \cdot {is}_{0} - {x}_{1} \cdot {is}_{1}}{i {s}_{0}^{2} - i {s}_{1}^{2}}$$

$${N}^{′} = \frac{{x}_{0} \cdot {is}_{1} - {x}_{1} \cdot {is}_{0}}{i {s}_{0}^{2} - i {s}_{1}^{2}}$$

$${C}^{′} = \frac{{x}_{3} \cdot {is}_{3} + {x}_{2} \cdot {is}_{2}}{i {s}_{2}^{2} + {is}_{3}^{2}}$$

$${S}^{′} = \frac{- {x}_{3} \cdot {is}_{2} + {x}_{2} \cdot {is}_{3}}{i {s}_{2}^{2} + {is}_{3}^{2}}$$

Systems herein may calculate normalized ellipsometric parameters N, C, and S, and other related quantities as previously shown, and the resulting values may be displayed and/or stored for further processing.

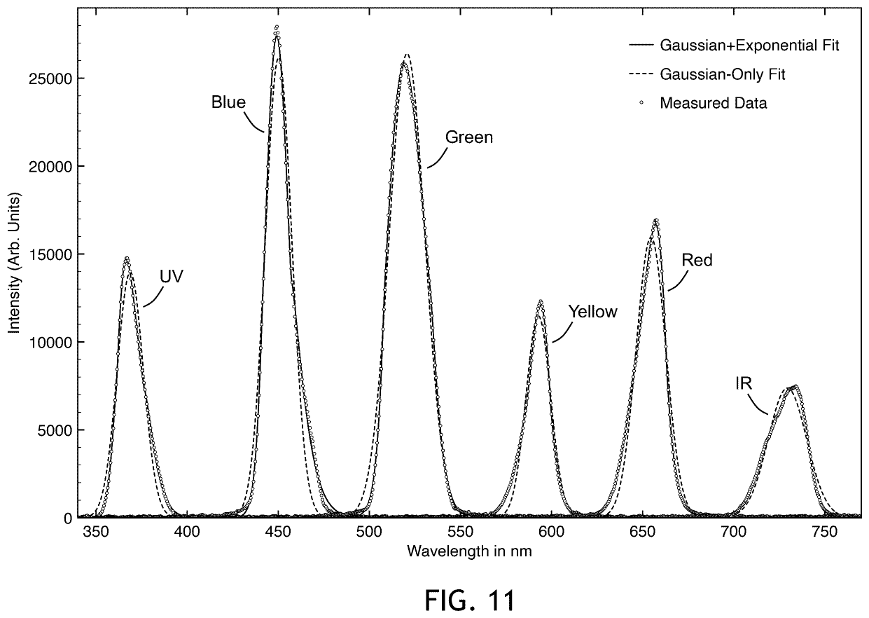

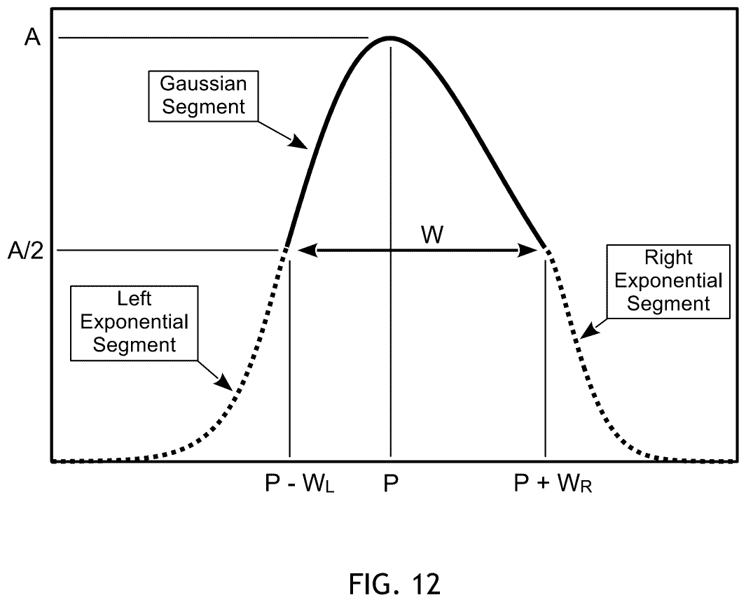

Embodiments of the present disclosure improve the accuracy of optical model-based analysis of acquired ellipsometric data sets. As previously mentioned, one disadvantage of using light emitting diodes (LEDs) for light sources is their large bandwidth. This is illustrated by FIG. 11, which shows the measured intensity spectrum vs. wavelength for 6 LEDs (UV, blue, green, yellow, red, IR) as filled circle symbols. The dashed lines on the FIG. 11 are from a least squares fit to the measured data sets assuming the well-known Gaussian lineshape. The Gaussian lineshape does not fit the measured LED intensity vs. wavelength curves very well: the peak height and position of the dashed Gaussian curves do not match the measured data circles, and the data fit in the tail regions may also be poor, due to the asymmetrical, broad tails in the measured data. In the present disclosure, a significantly improved fit to the measured LED lineshape spectra may be provided by a piece-wise continuous function of Gaussian and Exponential lineshapes. An embodiment of the Gaussian+Exponential lineshape is schematically shown in FIG. 12, and the corresponding function GE(x) is defined as:

$$If x < P - {W}_{L} then GE ( x ) = \frac{A}{2} \cdot {e}^{- {e}^{( {E}_{L 2} \cdot ln ( \frac{P - {W}_{L} - x}{{E}_{L}} ) )}}$$

$$If x > P + {W}_{R} then GE ( x ) = \frac{A}{2} \cdot {e}^{- {e}^{( {E}_{R 2} \cdot ln ( \frac{x - P - {W}_{R}}{{E}_{R}} ) )}}$$

$$Otherwise , GE ( x ) = A \cdot {e}^{- {( \frac{K \cdot ( x - P )}{( x - P ) \cdot S + B} )}^{2}}$$

$$where$$

$$K = \sqrt{- ln ( \frac{1}{2} )} , {W}_{L} = \frac{1}{2} W \cdot ( 1 - S ) , {W}_{R} = \frac{1}{2} W \cdot ( 1 + S ) , B = \frac{1}{2} W \cdot ( 1 - {S}^{2} )$$

In the preceding GE(x) formula, x is in nm, A is the amplitude, P is the peak wavelength in nm, W is the full width half maximum (FWHM) of the lineshape in nm, E_{L} is the decay constant for the left exponential tail, E_{R} is the decay constant for the right exponential tail, S specifies the symmetry of the Gaussian, the E_{L2} and E_{R2} terms specify the mixture between exponential and Gaussian segments, and the constant K adjusts the amplitude of the Gaussian expression to ½ at the FWHM points defined by W.

FIG. 12 illustrates the piece-wise continuous Gaussian+Exponential lineshape function GE(x). Note that the Gaussian+Exponential lineshape function does have a discontinuity in its derivatives at the transition between the Gaussian and Exponential segments, which may limit the general applicability of this lineshape. However, the Gaussian+Exponential lineshape function provides excellent fits to the measured LED lineshapes, as was demonstrated in FIG. 11.

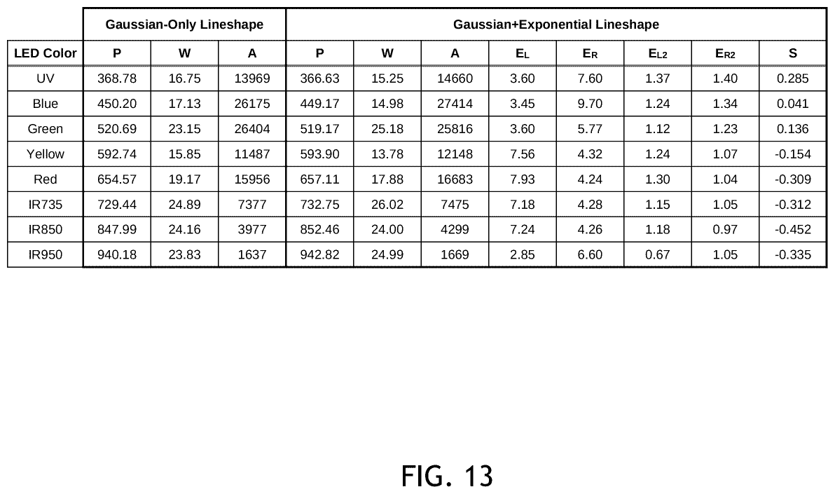

To improve the analysis accuracy for ellipsometric data acquired with a system 100, the first step is to measure the intensity spectrum of each light source in the PSG 110. This is done using an external spectrometer that is not part of system 100. Next, the measured intensity spectrum for each light source is fit using the Gaussian+Exponential lineshape function previously described. For the spectra shown in FIG. 11, the Gaussian+Exponential lineshape characterizing parameters, as determined by a non-linear least-squares regression analysis of the measured spectra, are shown in FIG. 13. For comparison, FIG. 13 also lists the lineshape characterizing parameters using a Gaussian-only lineshape. The next step in improving the data analysis accuracy is to incorporate the measured lineshape functions into the optical model which is used to generate calculated data in the analysis of the ellipsometric data. Well-known descriptions of ideal optical model calculation may assume illumination of the sample 202 by monochromatic light. The output of the optical model calculation are the complex rₚ and rₛ reflectivities for the model at each wavelength. If the illuminating light is not monochromatic, measured response is a weighted sum over all the light source wavelengths which are illuminating the sample 202. Mathematically, this may be written as the well-known convolution integral:

$$M ( λ ) = \int S ( {λ}^{′} ) b ( {λ}^{′} - λ ) d {λ}^{′}$$

In the convolution integral above, S(λ) is the ideal function and b(λ′−λ) is the lineshape function, which are convolved together to form the measured function M(λ). Since the multiple wavelengths illuminating the sample 202 are not coherent with each other, the convolution must be done over calculated intensity values (to suppress the interference between multiple wavelengths), as opposed to calculated field amplitudes (which maintain the interference between multiple wavelengths). However, the intensity convolution must still maintain the phase information which is measured by ellipsometry. This situation is analogous to the films with non-uniform thickness measured by G. E. Jellison, Jr. and J. W. McCamy, Sample depolarization effects from thin films of ZnS on GaAs as measured by spectroscopic ellipsometry, APPL. PHYS. LETT., 61, 512 (1992), and the incoherent substrate backside reflection studied by R. Joerger, et. al., Influence of incoherent superposition of light on ellipsometric coefficients, APPLIED OPTICS, 36, 319 (1997), both of which are incorporated by reference herein in their entirety. Joerger shows that for ellipsometry, the quantities to be integrated are |rₚ|², |rₛ|², Re(rₚ rₛ*), and Im(rₚ rₛ*), which correspond to the intensities of p-polarized and s-polarized reflected light, and the real and imaginary parts of the product of rₚ and the complex conjugate of rₛ. The appropriate convolution integrals to account for the light source bandwidth are written as:

$$〈 {R}_{p} 〉 = \int {\vert {r}_{p} ( {λ}^{′} ) \vert}^{2} GE ( {λ}^{′} - λ ) d {λ}^{′}$$

$$〈 {R}_{s} 〉 = \int {\vert {r}_{s} ( {λ}^{′} ) \vert}^{2} GE ( {λ}^{′} - λ ) d {λ}^{′}$$

$$Re 〈 {r}_{p} {r}_{s}^{*} 〉 = \int Re ( {r}_{p} ( {λ}^{′} ) \cdot {{r}_{s} ( {λ}^{′} )}^{*} ) GE ( {λ}^{′} - λ ) d {λ}^{′}$$

$$Im 〈 {r}_{p} {r}_{s}^{*} 〉 = \int Im ( {r}_{p} ( {λ}^{′} ) \cdot {{r}_{s} ( {λ}^{′} )}^{*} ) GE ( {λ}^{′} - λ ) d {λ}^{′}$$

The rₚ(λ) and rₛ(λ) functions are evaluated by the ideal optical model calculation, and the GE(λ) function is the Gaussian+Exponential lineshape function, with the parameters previously determined from the spectral measurement of the light source. The < > brackets indicate the convolved or “averaged” values. The integrals may be numerically evaluated using Simpson's rule, and more complex numerical integration algorithms such as Gaussian Quadrature. The formulas to calculate the measured ellipsometric parameters from the averaged values are also found in the Joerger paper, but the formulas below have been simplified and switched to the N, C, S notation used throughout the rest of this disclosure.

$$N = \frac{〈 {R}_{s} 〉 - 〈 {R}_{p} 〉}{〈 {R}_{s} 〉 + 〈 {R}_{p} 〉} C = \frac{2 \cdot Re 〈 {r}_{p} {r}_{s}^{*} 〉}{〈 {R}_{s} 〉 + 〈 {R}_{p} 〉} S = \frac{2 \cdot Im 〈 {r}_{p} {r}_{s}^{*} 〉}{〈 {R}_{s} 〉 + 〈 {R}_{p} 〉} P = \sqrt{{N}^{2} + {C}^{2} + {S}^{2}}$$

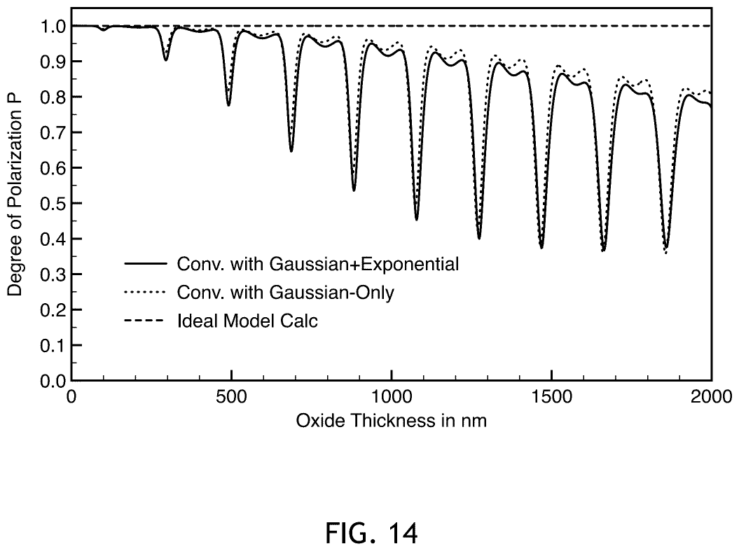

It should be noted that the degree of polarization P may in general be less than one, due to the depolarizing effects of the large bandwidth LED light source, and the value of P may be highly dependent on the thickness of the film on the sample 202. An example of the optical model calculation including the effects of the large LED bandwidth is shown in FIG. 14. For this example, the optical model used a silicon substrate with a silicon dioxide film, an angle of incidence of 65°, and the lineshape characterizing parameters of the blue LED shown in FIG. 13. The optical model was calculated over a range of film thicknesses, from 0 to 2000 nm. FIG. 14 plots the degree of polarization P vs. film thickness. The degree of polarization for the ideal model calculation (dashed line) is constant and equal to one. The degree of polarization curves for the model calculation using convolution with the Gaussian+Exponential lineshape (solid line) and Gaussian-Only lineshape (dotted line) exhibit significant structure vs. film thickness. While the structure may be similar, there are still noticeable differences between the curves calculated using convolution with the Gaussian+Exponential lineshape and the Gaussian-Only lineshape.

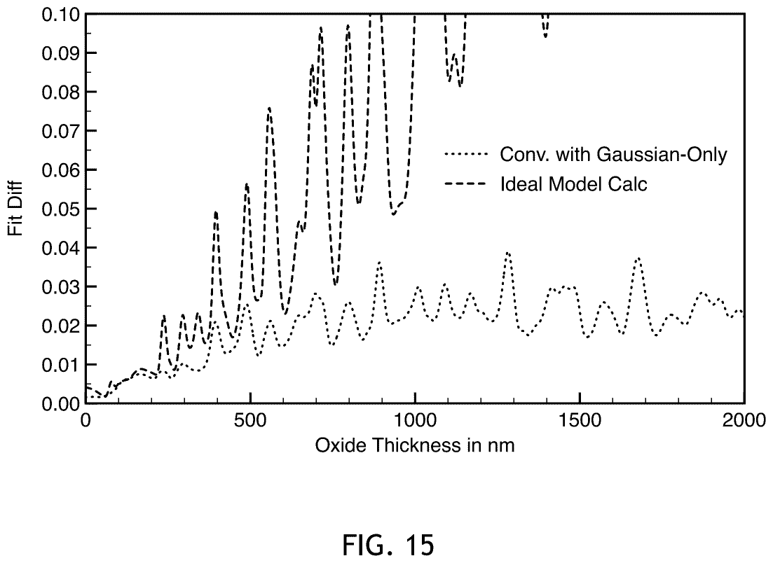

FIG. 15 illustrates the impact of the LED bandwidth on the Fit Diff parameter vs. film thickness. The Fit Diff quantifies the “goodness of fit” of the analysis model with respect to the experimental ellipsometric data, is defined as the root mean square difference between the measured and model calculated ellipsometric data. If the LED bandwidth is not included in the model calculation, the Fit Diff parameter becomes very large as the film thickness increases, as shown by the dashed curve in FIG. 15. If a Gaussian-Only lineshape is used for the LED bandwidth convolution, the Fit Diff still increases to ~ 0.03 for thicker films (ideally the Fit Diff should be less than 0.001). Therefore, to avoid inducing significant errors in the analysis of ellipsometric data acquired with LED light sources, it is important to implement the Gaussian+Exponential lineshape in the light source bandwidth convolution integral.

Specific blocks, sections, devices, functions, processes and modules may have been set forth. However, a skilled technologist will realize that there are many ways to partition the system, and that there are many parts, components, processes, modules and functions that may be substituted for those listed above.

While the above detailed description has shown, described and pointed out the fundamental novel features of the invention as applied to various embodiments, it will be understood that various omissions and substitutions and changes in the form and details of the system illustrated may be made by those skilled in the art, without departing from the intent of the invention. The foregoing description details certain embodiments of the invention. It will be appreciated, however, that no matter how detailed the foregoing appears, the invention may be embodied in other specific forms without departing from its spirit and essential characteristics. The described embodiment is to be considered in all respects only as illustrative and not restrictive and the scope of the invention is, therefore, indicated by the appended claims rather than by the foregoing description. All changes which come within the meaning and range of equivalency of the claims are to be embraced within their scope.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that a preferred vehicle may vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, and predictability) of the implementer, any of which may vary. Those skilled in the art will recognize that optical aspects of implementations will typically employ optically oriented hardware, software, and/or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device-detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively, or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively, or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware may be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art may recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those skilled in the art will recognize that the subject matter described herein may be implemented in an analog or digital fashion or some combination thereof.

Those skilled in the art may recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

One skilled in the art may recognize that the herein described components (e.g., operations), devices, objects, and the discussion accompanying them are used as examples for the sake of conceptual clarity and that various configuration modifications are contemplated. Consequently, as used herein, the specific examples set forth and the accompanying discussion are intended to be representative of their more general classes. In general, use of any specific example is intended to be representative of its class, and the non-inclusion of specific components (e.g., operations), devices, and objects should not be taken limiting.

Although a user is shown/described herein as a single illustrated figure, those skilled in the art will appreciate that the user may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be the of “sender” and/or other entity-oriented terms as such terms are used herein unless context dictates otherwise.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable components, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art may understand the convention (e.g., “a system having at least one of A, B, and C” may include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art may understand the convention (e.g., “a system having at least one of A, B, or C” may include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.

With respect to the appended claims, those skilled in the art may appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A multiple wavelength ellipsometer system, comprising:
a polarization state generator, including:
a plurality of solid state light sources; and
a no moving parts polarimeter, including:
a first polarimeter section with an aperture configured to receive an incident beam;
a plurality of detectors configured to receive the incident beam and convert the incident beam into one or more detector signals, wherein the plurality of detectors are mounted in one plane;
a second polarimeter section including a first partially reflecting optic oriented to partially reflect the incident beam on to a first detector of the plurality of detectors, and to transmit a first remaining incident beam;
a third polarimeter section including a second partially reflecting optic oriented to partially reflect the incident beam on to a second detector of the plurality of detectors, and to transmit a second remaining incident beam;
a fourth polarimeter section including a third partially reflecting optic oriented to partially reflect the incident beam on to a third detector of the plurality of detectors, and to transmit a third remaining incident beam;
a fifth polarimeter section including a fourth partially reflecting optic oriented to partially reflect the incident beam on to a fourth detector of the plurality of detectors, and to transmit a fourth remaining incident beam;
a sixth polarimeter section including a reflecting optic oriented to reflect the remaining incident beam on to a fifth detector of the plurality of detectors, wherein the fifth detector is a position sensitive detector; and
at least one retarder element positioned in at least one of: between the second polarimeter section and the third polarimeter section, between the third polarimeter section and the fourth polarimeter section, or between the fourth polarimeter section and the fifth polarimeter section.

2. The multiple wavelength ellipsometer system of claim 1, wherein the plurality of detectors are mounted onto one circuit board.

3. The multiple wavelength ellipsometer system of claim 2, wherein at least one of the detectors is tilted relative to the plane in which the plurality of detectors are mounted.

4. The multiple wavelength ellipsometer system of claim 1, wherein the first polarimeter section includes a focus lens.

5. The multiple wavelength ellipsometer system of claim 1, wherein the partially reflecting optics are uncoated transparent glass plates.

6. The multiple wavelength ellipsometer system of claim 1, wherein the azimuthal orientation of the planes of incidence of partially reflecting optics are:
0° for the first partially reflecting optic;
±45° for the second partially reflecting optic;
±45° for the third partially reflecting optic; and
0° for the fourth partially reflecting optic.

7. The multiple wavelength ellipsometer system of claim 6, wherein the azimuthal orientation of the retarder element is ±45°.

8. The multiple wavelength ellipsometer system of claim 1, wherein the plurality of solid state light sources are mounted in one plane.

9. The multiple wavelength ellipsometer system of claim 1, wherein the plurality of solid state light sources are mounted onto one circuit board.

10. The multiple wavelength ellipsometer system of claim 1, further comprising:
a sample housing configured to receive and support a sample; and
a common frame configured to support and orient the polarization state generator, the sample housing, and the no moving parts polarimeter.

11. The multiple wavelength ellipsometer of claim 10, wherein the polarization state generator further includes:
a first lens configured to collimate the beams from the plurality of solid state light sources;
a diffraction grating configured to diffract the output beams from the plurality of solid state light sources into a common beam that is focused by the first lens on to a pinhole;
a second lens configured to collimate the common beam which is transmitted through the pinhole;
a rotatable polarizer optic azimuthally rotated by a computer controlled motor or a manually rotatable mechanism; and
an aperture to define a diameter of the collimated common beam transmitted through the pinhole.

12. The multiple wavelength ellipsometer system of claim 11, wherein the common frame is configured to orient the multiple wavelength ellipsometer system for a plurality of ellipsometer operations including two or more of:
a straight through mode of ellipsometer operation wherein the common beam is directly pointed into the polarimeter;
an off sample mode of ellipsometer operation wherein the common beam is directed toward a sample and at least one of: reflected from the sample into the polarimeter, or transmitted through the sample into the polarimeter; and
an in situ mode of ellipsometer operation wherein the common frame includes a chamber and the sample is mounted within the chamber, the chamber having a first window for receiving the common beam and transmitting the received common beam to the sample, and a second window for receiving a reflected beam from the sample and transmitting the reflected beam to the no moving parts polarimeter.

13. The multiple wavelength ellipsometer system of claim 11, wherein at least one processor is configured to control the plurality of solid state light sources, the control including:
sequentially cycling the plurality of solid state lights sources through a series of states, each of the series of states including at least one solid state light source illuminated, or none of the solid state light sources illuminated; and
digitizing and storing the detector signals during each of the series of states for further processing.

14. The multiple wavelength ellipsometer system of claim 13, wherein the at least one processor is further configured to perform a calibration to determine a four by four instrument matrix for each wavelength, the calibration comprising steps of:
configuring the multiple wavelength ellipsometer system in the straight through mode;
inserting a rotatable calibration waveplate into a common beam path between the polarization state generator and the no moving parts polarimeter;
rotating the calibration waveplate to one or more azimuthal orientations;
rotating the rotatable polarizer optic to at least two azimuthal orientations at each of the one or more azimuthal orientations of the calibration waveplate;
storing first output signals from the detectors at each of the one or more azimuthal orientations of the calibration waveplate and at each of the at least two azimuthal orientations of the rotatable polarizer optic;
removing the rotatable calibration waveplate from the common beam path;
rotating the rotatable polarizer optic in the polarization state generator to at least two azimuthal orientations;
storing second output signals from the detectors at each of the at least two azimuthal orientations of the rotatable polarizer optic; and
determining, via a non-linear regression analysis and a Mueller matrix model of the device optical components, the four by four instrument matrix for each wavelength based on: the first and second stored output signals from the detectors, the at least two azimuthal orientations of the polarizer optic, the at least one azimuthal orientation of the calibration waveplate, and a retardation of the calibration waveplate at each wavelength.

15. The multiple wavelength ellipsometer system of claim 14, wherein the at least one processor is further configured to perform an acquisition of ellipsometric data, the acquisition of the ellipsometric data comprising steps of:
mounting a sample on the common frame;
aligning a polarizer optic within the polarization state generator to an operating azimuthal angle;
receiving a plurality of detector signals for at least one wavelength from the plurality of solid state light sources;
arranging the plurality of detector signals into a four by one signal vector for the at least one wavelength;
multiplying the four by one signal vector for the at least one wavelength by an inverse of a four by four instrument matrix to form a four by one product vector, the four by four instrument matrix based on a calibration of the polarization state generator and the no moving parts polarimeter;
determining at least one ellipsometric data parameter for the wavelength based on the four by one product vector;
storing the determined at least one ellipsometric data parameter for further processing; and
displaying the at least one ellipsometric data parameter to a user on a display.

16. The multiple wavelength ellipsometer system of claim 15, wherein the at least one processor is further configured to implement a window calibration of an in situ mode of ellipsometer operation with at least one window in the common beam path, the window calibration comprising steps of:
determining an optical model for a reference sample by acquiring ellipsometric data on the reference sample without the at least one window in the common beam path;
positioning the reference sample on the common frame and with the at least one window in the common beam path;
determining a window calibration data set by acquiring ellipsometric data on the reference sample at multiple orientations of the azimuthally rotatable polarizer optic;
determining an ellipsometric N parameter and a window-related Mueller matrix element for at least one wavelength based on the window calibration data set;
determining an angle of incidence of the common beam with respect to the reference sample based on the ellipsometric N parameter;
determining an ellipsometric C parameter and an ellipsometric S parameter for the reference sample based on the optical model of the reference sample and the angle of incidence of the common beam;
determining at least one window characterizing parameter based on the window-related Mueller matrix element, the ellipsometric N parameter, the ellipsometric C parameter, and the ellipsometric S parameter for the reference sample; and
storing the at least one window characterizing parameter for use in acquiring ellipsometric data on a subsequent sample to increase the accuracy of the ellipsometric data.

17. The multiple wavelength ellipsometer system of claim 15, wherein the at least one processor is further configured to perform an analysis of the ellipsometric data, the analysis of the ellipsometric data comprising steps of:
measuring an intensity versus wavelength for each light source of the plurality of solid state light sources;
determining a plurality of lineshape characterizing parameters for each light source of the plurality of solid state light sources by fitting a piece-wise continuous function to the intensity versus wavelength curves for each light source of the plurality of solid state light sources, the piece-wise continuous function have a central Gaussian-like lineshape component and an adjacent exponential-like lineshape component;
building an optical model for the sample representative of a nominal structure of the sample, the optical model calculation including a convolution with the fitted piece-wise continuous function with the central Gaussian-like lineshape component and the adjacent exponential-like lineshape component;
analyzing the ellipsometric data via a non-linear regression analysis from the optical model for the sample to determine at least one sample characterizing parameter;
storing the determined at least one sample characterizing parameter for further processing; and
displaying the at least one sample characterizing parameter to a user on a display.

18. The multiple wavelength ellipsometer system of claim 15, wherein the at least one processor is further configured to improve the accuracy of the ellipsometric data when the common incident beam is misaligned to the no moving parts polarimeter by performing steps of:
using the detector signals from the position sensitive detector to calculate the misalignment angles of the common beam to the no moving parts polarimeter;
using the misalignment angles of the common beam, and a Mueller matrix model of the device optical components determined during the instrument calibration, to calculate a misalignment correction matrix for the four by four instrument matrix at each wavelength; and
using the four by four instrument matrix plus the misalignment correction matrix to calculate ellipsometric data with improved accuracy.

19. The multiple wavelength ellipsometer system of claim 1, wherein beams reflected from surfaces of the plurality of detectors are absorbed by blackened regions or holes on a frame of the no moving parts polarimeter.

20. A multiple wavelength ellipsometer system, comprising:
a polarization state generator having a plurality of solid state light sources; and
a polarization state detector having no moving parts;
the polarization state detector comprising:
a) a plurality of polarimeter sections;
b) a plurality of detectors mounted in one plane; and
c) at least one retarder element positioned between polarimeter sections.
